(19) United States
(12) Patent Application Publication
(10) Pub. No.: US 2014/0279778 A1
(43) Pub. Date: Sep. 18, 2014

(54) Systems and Methods for Time Encoding and Decoding Machines

(71) Applicant: The Trustees of Columbia University in the city of New York, New York, NY (US)

(72) Inventors: Aurel A. Lazar, New York, NY (US); Yevgeniy B. Slutskiy, Brooklyn, NY (US)

(73) Assignee: The Trustees of Columbia University in the city of New York, New York, NY (US)

(21) Appl. No.: 14/218,736

(22) Filed: Mar. 18, 2014

Related U.S. Application Data
(60) Provisional application No. 61/802,986, filed on Mar. 18, 2013.
(60) Provisional application No. 61/803,391, filed on Mar. 19, 2013.

(51) Int. Cl. G06N 3/02

(52) U.S. Cl. CPC G06N 3/02
USPC 706/22

(57) ABSTRACT

Systems and methods for system identification, encoding and decoding signals in a non-linear system are disclosed. An exemplary method can include receiving the one or more input signals and performing dendritic processing on the input signals. The method can also encode the output of the dendritic processing of the input signals, at a neuron, to provide encoded signals.

### CROSS-REFERENCE TO RELATED APPLICATIONS

This application is related to U.S. Provisional Application Ser. No. 61/802,986, filed on Mar. 18, 2013; U.S. Provisional Application Ser. No. 61/803,391, filed on Mar. 19, 2013, each of which is incorporated herein by reference in its entirety and from which priority is claimed.

### STATEMENT REGARDING FEDERALLY-SPONSORED RESEARCH

This invention was made with government support under Grant No. FA9550-12-1-0232 awarded by the Air Force Office of Scientific Research and Grant No. R021 DCO 12440001 awarded by the National Institutes of Health. The government has certain rights in the invention.

### BACKGROUND

The disclosed subject matter relates to techniques for identifying parameters of nonlinear systems and decoding signals encoded with nonlinear systems.

To analyze sensory systems, neurons can be used to represent and process external analog sensory stimuli. Decoding can be used to invert the transformation in the encoding and reconstruct the sensory input when the sensory system and the outputs are known. Decoding can be used to reconstruct the stimulus that generated the observed spike trains based on the encoding procedure of the system. Existing technologies can provide techniques for encoding and decoding sensory systems in a linear system.

Signal distortions introduced by a communication channel can affect the reliability of communication systems. Understanding how channels or systems distort signals can help to correctly interpret the signals sent. In practice, however, information about the channel or system is often not available a priori. Certain technologies for system identification can identify the systems in a linear system. However, there exists a need for an improved method for performing system identification, encoding, and decoding in non-linear systems.

### SUMMARY

Systems and methods for system identification, encoding and decoding signals in a non-linear system are disclosed herein.

In one aspect of the disclosed subject matter, techniques for encoding signals in a non-linear system are disclosed. An exemplary method can include receiving input signals and performing dendritic processing on the input signals. The method can also encode the output of the dendritic processing at a neuron to provide encoded signals.

In some embodiments, the method can include modeling the input signals using Volterra series. In some embodiments, the method can also include modeling the input signals into one or more orders.

In one aspect of the disclosed subject matter, techniques for decoding signals in a non-linear system are disclosed. An exemplary method can include receiving one or more encoded signals and performing convex optimization of the encoded signals. The method can further include constructing output signals using the convex optimization of the encoded signals.

In one aspect of the disclosed subject matter, techniques for identifying a projection of an unknown dendritic processor in a non-linear system are disclosed. An exemplary method can include receiving a known input signal and processing the known input signal using the projection of an unknown dendritic processor into a first output. The method can further include encoding the first output to produce an output signal. The method can also include identifying the projection of the unknown dendritic processor based on comparing the known input signal and the output signal.

Systems for encoding signals in a non-linear system are also disclosed. In one embodiment, an example system can include a first computing device that has a processor and a memory for the storage of executable instructions and data, where the instructions are executed to encode the signals in a non-linear system.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The accompanying drawings, which are incorporated and constitute part of this disclosure, illustrate some embodiments of the disclosed subject matter.

FIG. 1A illustrates an exemplary system in accordance with the disclosed subject matter.

FIG. 1B illustrates an exemplary Time Encoding Machine (TEM) in accordance with the disclosed subject matter.

FIG. 1C illustrates an exemplary Time Decoding Machine (TDM) in accordance with the disclosed subject matter.

FIG. 1D illustrates an exemplary block diagram of an encoder unit that can perform encoding on signals in accordance with the disclosed subject matter.

FIG. 1E illustrates an exemplary block diagram of the encoder unit that can perform encoding on input signal in accordance with the disclosed subject matter.

FIG. 1F illustrates an exemplary block diagram of an embodiment of an encoder unit 199 in accordance with the disclosed subject matter.

FIG. 1G illustrates an exemplary block diagram of a single input single output (SISO) encoder unit in accordance with the disclosed subject matter.

FIG. 1H illustrates an exemplary block diagram of a multiple input single output (MISO) encoder unit in accordance with the disclosed subject matter.

FIG. 2A illustrates an exemplary block diagram of a decoder unit that can perform decoding on encoded signals in accordance with the disclosed subject matter.

FIG. 2B illustrates an exemplary time encoding interpretation of system identification and block diagram of an exemplary system that performs the system identification in accordance with the disclosed subject matter.

FIG. 3 illustrates an exemplary method to encode a signal in accordance with the disclosed subject matter.

FIG. 4 illustrates another exemplary method to encode a signal in accordance with the disclosed subject matter.

FIG. 5 illustrates an exemplary method to decode an encoded signal in accordance with the disclosed subject matter.

FIG. 6 illustrates an exemplary method to identify an unknown system in accordance with the disclosed subject matter.

FIG. 7A and FIG. 7B illustrate an exemplary Multiple-input and Multiple-output neural circuit architecture model for nonlinear processing and encoding in accordance with the disclosed subject matter.

FIG. 8A, FIG. 8B, FIG. 8C, and FIG. 8D illustrate exemplary DSP examples in accordance with the disclosed subject matter.

FIG. 9 illustrates an exemplary neural circuit that includes 1) a SISO DSP, which performs a nonlinear analog processing and 2) an ideal IAF encoder in cascade with the SISO DSP—where the exemplary neural circuit has a temporal input u₁ in accordance with the disclosed subject matter.

FIG. 10A and FIG. 10B illustrate an exemplary SIMO Volterra TDM algorithm in accordance with the disclosed subject matter.

FIG. 11A and FIG. 11B illustrate an exemplary block diagram of the identification procedure and algorithm in accordance with the disclosed subject matter.

FIG. 12A and FIG. 12B illustrate exemplary kernels of a temporal SISO DSP with a maximal order P=2 in accordance with the disclosed subject matter.

FIG. 13A, FIG. 13B, FIG. 13C, FIG. 13D, FIG. 13E, FIG. 13F, FIG. 13G, and FIG. 13H illustrate an exemplary input/output behavior of the temporal SISO DSP in accordance with the disclosed subject matter.

FIG. 14A, FIG. 14B, FIG. 14C, and FIG. 14D illustrate an exemplary decoding example of a temporal SISO DSP in accordance with the disclosed subject matter.

FIG. 15A, FIG. 15B, FIG. 15C, and FIG. 15D illustrate an exemplary decoding example of a temporal MISO DSP in accordance with the disclosed subject matter.

FIG. 16 illustrates identification example of a motion energy DSP in accordance with the disclosed subject matter.

FIG. 17A, FIG. 17B, FIG. 17C, FIG. 17D, FIG. 17E, FIG. 17F, FIG. 17G, and FIG. 17H illustrate an exemplary identification example of gain control adaptation DSP in accordance with the disclosed subject matter.

FIG. 18A, FIG. 18B, and FIG. 18C illustrate an exemplary identification example of a squaring of a signal in accordance with the disclosed subject matter.

FIG. 19A, FIG. 19B, FIG. 19C, and FIG. 19D illustrate an exemplary necessary and sufficient conditions for decoding and identification in accordance with the disclosed subject matter.

### DESCRIPTION

Techniques for system identification, encoding and decoding signals in a non-linear system are presented. An exemplary technique includes receiving the one or more input signals and performing dendritic processing on the input signals. The method can also encode the output of the dendritic processing of the input signals, at a neuron, to provide encoded signals. It should be understood that system identification can be channel identification.

FIG. 1A illustrates an exemplary system in accordance with the disclosed subject matter. With reference to FIG. 1A, signals 101, for example input signals, are received by an encoder unit 141, 143, and 145. The encoder unit 199 can encode the input signals 101 and provide the encoded signals to a control unit or a computer unit 195. The encoded signals can be digital signals that can be read by a control unit 195. The control unit 195 can read the encoded signals, analyze, and perform various operations on the encoded signals. The encoder unit 141, 143, and 145 can also provide the encoded signals to a network 196. The network 196 can be connected to various other control units 195 or databases 197. The database 197 can store data regarding the signals 101 and the different units in the system can access data from the database 197. The database 197 can also store program instructions to run the disclosed subject matter. The system also consists of a decoder 231 that can decode the encoded signals, which can be digital signals, from the encoder unit 199. The decoder 231 can recover the analog signal 101 encoded by the encoder unit 199 and output an analog signal 241, 243 accordingly.

For purposes of this disclosure, the database 197 and the control unit 195 can include random access memory (RAM), storage media such as a direct access storage device (e.g., a hard disk drive or floppy disk drive), a sequential access storage device (e.g., a tape disk drive), compact disk, CD-ROM, DVD, RAM, ROM, electrically erasable programmable read-only memory (EEPROM), and/or flash memory. The control unit 195 can further include a processor, which can include processing logic configured to carry out the functions, techniques, and processing tasks associated with the disclosed subject matter. Additional components of the database 197 can include one or more disk drives. The control unit 195 can include one or more network ports for communication with external devices. The control unit 195 can also include a keyboard, mouse, other input devices, or the like. A control unit 195 can also include a video display, a cell phone, other output devices, or the like. The network 196 can include communications media such wires, optical fibers, microwaves, radio waves, and other electromagnetic and/or optical carriers; and/or any combination of the foregoing.

FIG. 1B illustrates an exemplary Time Encoding Machine (TEM) in accordance with the disclosed subject matter. It should be understood that a TEM can also be understood to be an encoder unit 199. In one embodiment, Time Encoding Machines (TEM) can be asynchronous nonlinear systems that encode analog signals into multi-dimensional spike trains. With reference to FIG. 1B, a TEM 199 is a device which encode analog signals 101 as monotonically increasing sequences of irregularly spaced times 102. A TEM 199 can output, for example, spike time signals 102, which can be read by computers. In one embodiment, the TEM can be based on time sequences instead of rate-based models.

FIG. 1C illustrates an exemplary Time Decoding Machine (TDM) in accordance with the disclosed subject matter. It should be understood that a TDM can also be understood to be a decoder unit 231. In one embodiment, Time Decoding Machines (TDMs) can reconstruct time encoded analog signals from spike trains. With reference to FIG. 1C, a TDM 231 is a device which converts Time Encoded signals 102 into analog signals 241, 243 which can be actuated on the environment. Time Decoding Machines 231 can recover the signal loss-free. In one example, a TDM can be a realization of an algorithm that recovers the analog signal from its TEM counterpart. In one embodiment, the TDM can be based on time sequences instead of rate-based models.

FIG. 1D illustrates an exemplary block diagram of an encoder unit 199 that can perform encoding on signals 101 in accordance with the disclosed subject matter. In another embodiment, more than one input signals 101 can be used. With reference to FIG. 1D, analog signals 101 are received by the encoding unit 199. The analog signals 101 are provided as an input to dendritic stimulus processors 105, 106, 107, 108, 109, which performs, for example, an operation on the input 101. The output from the dendritic stimulus processing operation 105, 106, 107, 108, 109 is then provided as an input to the neurons 117, 119, 121. The neurons 117, 119, 121 perform encoding on the input and the neurons 117, 119, 121 output encoded signals 102. An example of the encoded signals can be spike trains.

FIG. 1E illustrates an exemplary block diagram of the encoder unit 199 that can perform encoding on input signal 101 in accordance with the disclosed subject matter. It should be understood that input signal 101 can be modeled into different orders 141 . . . 143. In another embodiment, more than one input signals 101 can be used. With reference to FIG. 1E, analog signal 101 is received by the encoding unit 199. In one embodiment, the signal 101 can be modeled into different orders of the signal 141 . . . 143. The different orders 141 . . . 143 of the input signal 101 are then provided as an input to the dendritic processors 105, 107, 109. The dendritic processors 105, 107, 109 can perform a processing operation on the different orders 141 . . . 143 of the input signal 101. In one example, the output 111, 113, 115 from the dendritic processors is provided to neurons 117, 119, 121 for encoding into encoded signals 123, 125, 127. The encoded signals can be, for example, spike trains. In one embodiment, one output from the dendritic processor 105, 107, 109 can be provided as an input to one neuron 117, 119, 121 for encoding.

FIG. 1F illustrates an exemplary block diagram of an embodiment of an encoder unit 199 in accordance with the disclosed subject matter. In one embodiment, the input signal 101 can be modeled into different orders 141 . . . 143 of the input signal 101. Each order can be provided as an input to a tree 133, 135 of the dendritic processor 105, 107, 109. Each tree 133, 135 of the dendritic processor 105, 107, 109 processes the input from the different orders 141 . . . 143 of the input signal 101. In one example, each tree 133, 135 can receive one input or one order 141 . . . 143 of the signal. Alternatively, each tree 133, 135 can receive more than one input or one order 141 . . . 143 of the signal. The output 181, 183 from the trees 133, 135 of each dendritic processor 105, 107, 109 can be summed or added 137 and provided 111, 113, 115 to a neuron 117, 119, 121 for encoding into encoded signals 123, 125, 127.

FIG. 1G illustrates an exemplary block diagram of a single input single output (SISO) encoder unit 199 in accordance with the disclosed subject matter. In one embodiment, the input signal 101 is provided as an input to one or more dendritic processors 105, 107, 109. In one example, the input signal 101 can be modeled into different orders 141 . . . 143. In another embodiment, more than one input signals 101 can be used. The outputs 181, 183, 185 from the dendritic processors 105, 107, 109 can be summed 111 and provided as an input to a neuron 117. The neuron 117 can encode the input 111 into encoded signal 102.

FIG. 1H illustrates an exemplary block diagram of a multiple input single output (MISO) encoder unit 199 in accordance with the disclosed subject matter. In one embodiment, the input signals 101 are provided as an input to one or more dendritic processors 105, 106, 107, 108, 109. In one example, the input signals 101 can be modeled into different orders 141 . . . 143. In one example, a dendritic processor 109 can receive input from more than one input signal 101. The outputs 181, 182, 183, 184, 185 from the dendritic processors 105, 106, 107, 108, 109 can be summed and provided as an input 111 to a neuron 117. The neuron 117 can encode the input 111 into encoded signal 102.

Each order can be provided as an input to a tree 133, 135 of the dendritic processor 105, 107, 109. Each tree 133, 135 of the dendritic processor 105, 107, 109 processes the input from the different orders 141 . . . 143 of the input signal 101. In one example, each tree 133, 135 can receive one input or one order 141 . . . 143 of the signal. Alternatively, each tree 133, 135 can receive more than one input or one order 141 . . . 143 of the signal. The output 181, 183 from the trees 133, 135 of each dendritic processor 105, 107, 109 can be summed or added 137 and provided 111, 113, 115 to a neuron 117, 119, 121 for encoding into encoded signals 123, 125, 127.

FIG. 2A illustrates an exemplary block diagram of a decoder unit 231 that can perform decoding on encoded signals 123, 125, 127 in accordance with the disclosed subject matter. With reference to FIG. 2A, encoded signals 123, 125, 127 are received by the decoding unit 231. An exemplary operation 201 can be performed on the encoded signals that results in coefficients 203, 205. Examples of the operation 201 include, but are not limited to, taking a pseudo-inverse of a matrix, multiplying matrices, solving a convex optimization problem, or the like. The coefficients 202, 203, 204, 205 of the operation 201 can be multiplied by basis 207, 209, 211, 213. The result of this operation 221, 223 and 225, 227 can be aggregated or summed together to form output reconstructed signals 241 . . . 243.

FIG. 2B illustrates an exemplary time encoding interpretation of system identification and block diagram of an exemplary system that performs the system identification in accordance with the disclosed subject matter. In one embodiment, an example of the time encoding interpretation 291 can be inputting the unknown system 261 into a known signal 263. In one example, the unknown system 261 can be the projections of unknown dendritic processors 261. In this example, the projections of dendritic processors 261 can be looked upon as being encoded into spike trains of neurons. The output of this 265 can then inputted into a neuron 267 that encodes the signal and provides an encoded signal 269. In another example interpretation 291, a known signal 263 can be inputted into an unknown system 261, the output 265 can then be inputted into a neuron 267 that encodes the signal and provides an encoded signal 269. An exemplary block diagram 293 of the a system that performs system identification can include decoding the encoded signal 269 in accordance with the disclosed subject matter in FIG. 2A and the unknown system 261 can be reconstructed 241, 243.

FIG. 3 illustrates an exemplary method to encode a signal in accordance with the disclosed subject matter. In one example, the encoder unit 199 receives signals 301. The encoder unit 199 then performs dendritic processing 105, 107, 109 on the signals 303. In one example, the encoder unit 199 performs non-linear dendritic processing 105, 107, 109 on the signals 303. The encoder unit 199 then encodes the output from the dendritic processing, using a neuron 117, 119, 121, into an encoded signal output 123, 125, 127—or a spike train output 305.

FIG. 4 illustrates another exemplary method to encode a signal in accordance with the disclosed subject matter. In one example, the encoder unit 199 receives signals 301. The encoder unit 199 then performs dendritic processing 105, 107, 109 on the signals 303. The output from the dendritic processors 105, 107, 109 can be aggregated or summed 401 and then provides as an input to a neuron 117, 119,121. The neuron 117, 119, 121, into an encoded signal output 123, 125, 127—or a spike train output 305.

FIG. 5 illustrates an exemplary method to decode an encoded signal in accordance with the disclosed subject matter. In one example, the decoder unit 231 receives encoded signals 501. The decoder unit 231 then determines the sampling matrix 503 and measurements from time of the encoded signals 505. The coefficients are then determined, where the coefficients are a function of sampling matrix and measurements 507. The output signal is then determined using the coefficient and a basis 509.

FIG. 6 illustrates an exemplary method to identify an unknown system in accordance with the disclosed subject matter. In one example the unknown system can include unknown dendritic processors in the system. In another example, the unknown system can perform nonlinear operations on the input. In one embodiment, a known signal is received 601. The known signal is then processed, for example by a nonlinear operation using projections of the unknown dendritic processors 603. The output from the processing 603 can be input into a neuron that can encode the signals and provide encoded signals (such as a spike train) 605. In one example, the projections of the unknown dendritic processors can then be identified based on the known input signal and the encoded output 607. In one example, the identification can include identifying the nonlinear processing that is performed by the unknown system on the known input signal.

### Example 1

### Volterra Time Encoding Machines (Neural Circuit Architecture)

FIG. 7A and FIG. 7B illustrate an exemplary Multiple-input and Multiple-output neural circuit architecture model for nonlinear processing and encoding in accordance with the disclosed subject matter. FIG. 7A illustrates that multiple stimuli are processed and encoded into multiple spike trains. FIG. 7B illustrates an exemplary block diagram of the circuit. As FIG. 7A and FIG. 7B further illustrate, dendritic stimulus processors implement computation, while point neurons or simply “neurons,” encode current into spikes. FIG. 7A illustrates an exemplary multi-input multi-output (MIMO) neural circuit in which Mε [symbol] input signals are processed and en-coded into spike trains by a population of Nε [symbol] neurons. Such a MIMO circuit can be in agreement with the basic neurobiological thought that any real neural circuit is a massively parallel system, employing a multitude of neurons to process and encode signals in a parallel fashion. The notion of a population of relatively slow neurons processing information in parallel can be used in the disclosed subject matter for the neural coding implications of nonlinear dendritic computation.

As further illustrated in FIG. 7A, every neuron i, i=1, . . . , N 117, 119, 121 can receive multiple input signals uₙ^{m}, m=1, . . . , M 141 . . . 143. Each neuron 117, 119, 121 can perform analog processing on the input signals 141 . . . 143 in the associated dendritic tree 105, 107, 109 and can encode the aggregate dendritic current 111, 113, 115 into a spike train 123, 125, 127 (tₖⁱ)kεz, where for any given spike index k of neuron i, tₖⁱ denotes timing of that spike. The super script m in uₙ^{m} denotes the input stimulus number and the subscript n indicates the dimensionality of the stimulus. For stimuli that are functions of time, e.g., the concentration of an odorant, or the presynaptic spike train, the dimensionality n=1. For multidimensional stimuli, n can be greater than one. For example, n=3 for monocular grayscale video stimuli, which are functions of a two-dimensional space and time.

As further illustrated in FIG. 7A, in one embodiment, it can be assumed that each neuron 117, 119, 121 in the population receives the same set of inputs 101, 102. In alternative embodiments, however, this need not be the case. The number of actual neurons 117, 119, 121 and their respective inputs can be determined by the anatomy and prior knowledge about the circuit function. Furthermore, in one embodiment, it can be assumed that the circuit is essentially feedforward and there are no connections between neurons. In one embodiment, lateral and feedback connections can be readily incorporated into the circuit.

As further illustrated in FIG. 7B, the dendritic tree 105, 107, 109 and the spike initiation zone/axon of each neuron 117, 119, 121 can be assigned distinct roles. In one embodiment, the dendritic tree 105, 107, 109 can be endowed with the ability to carry out computations, while the spike initiation zone can be treated as an asynchronous sampler, or encoder, that packages the results of analog processing into spikes 123, 125, 127, which are presumed to be particularly well-suited for carrying information down the axon.

FIG. 7B further illustrates a exemplary block diagram of the MIMO neural circuit model. Each neuron 117, 119, 121 can be endowed with (i) a dendritic stimulus processor (DSP) 105, 107, 109 that can transform multiple input signals 141 . . . 143 into a single function of time, i.e., the aggregate dendritic current 111, 113, 115, and (ii) a spike initiation zone described by a point neuron 117, 119, 121 model, or simply “neuron” for short.

### Example 2

### Space of Input Stimuli

In one embodiment the input stimuli uₙ^{m}, m=1, . . . , M can be modeled as elements of Reproducing Kernel Hilbert Spaces (RKHS). In one example, spaces of trigonometric polynomials can be used. However, the disclosed subject matter can apply to many other RKHSs (for example, Sobolev spaces and Paley-Wiener spaces or the like).

The disclosed subject matter can use the following definitions:

Definition 1:

The Space of Trigonometric Polynomials [symbol] ₙ is a Hilbert Space of Complex-Valued Functions

$$( Equation 1 )$$

$${u}_{n} ( {x}_{1} , … , {x}_{n} ) = {\sum }_{{l}_{1} = - {L}_{1}}^{{L}_{1}} … {\sum }_{{l}_{n} = - {L}_{n}}^{{L}_{n}} {u}_{{l}_{1} … {l}_{n}} {e}_{{l}_{1} … {l}_{n}} ( {x}_{1} , … , {x}_{n} ) ,$$

over the domain [symbol] ₙ=Π_{α=1}[0, T_{α}], where the coefficients μi_{1 . . .} iₙ ε [symbol] and the functions ei_{1 . . .} iₙ (x₁, . . . xₙ)=exp (υ_{α=1}ⁿjl_{α}Ω_{α}x_{α}/L_{α})/\sqrt{T₁ . . . Tₙ}, with j denoting the imaginary number. Here Ω_{α} is the bandwidth, L_{α} is the order, and T_{α}=2πL_{α}/Ω_{α} is the period in dimension x_{α}. [symbol] ₙ is endowed with the inner product [symbol] ·,· [symbol] : [symbol] ₙ× [symbol] ₙ→ [symbol] , where

$$( \text{?} , \text{?} ) = \text{?} \text{?} ( \text{?} , … , {x}_{n} ) \overline{\text{?} ( \text{?} , … , {x}_{n} ) \text{?}} … \text{?} . \\ \text{?} \text{indicates text missing or illegible when filed} \qquad Equation 2 )$$

Given (Equation 2), the set of elements {εl_{1 . . .} lₙ}, l_{α}=−L_{α}, . . . , L_{α} α=1, . . . n, forms an orthonormal basis in [symbol] ₙ. More-over, [symbol] ₙ is an RKHS with the reproducing kernel (RK)

$${K}_{n} ( \text{?} , … , {x}_{n} ; {y}_{1} , … , {y}_{n} ) \text{?} … \text{?} \text{?} ( \text{?} ) \overline{\text{?} ( \text{?} , … , {y}_{n} )} . \\ \text{?} \text{indicates text missing or illegible when filed} \qquad ( Equation 3 )$$

Remark 1: The fundamental property of the RKHS [symbol] ₙ is the reproducing property, which states that the value of the function uₙ at a point x=[x₁, . . . , xₙ] is reproduced by the inner product of uₙ with the kernel Kₙ(, x). In other words, uₙ(x)=(uₙ(), Kₙ(, x)).

Remark 2: In one embodiment of the disclosed subject matter, temporal and spatiotemporal stimuli can be used, and the n^{th} dimension xₙ will denote the temporal dimension t of the stimulus, i.e., xₙ=t.

In one embodiment, uₙ including naturalistic stimuli, can be modeled as functions in an appropriately chosen space [symbol] ⁿ. Thus, the same machinery can be used to parameterize synthetic stimuli produced in the lab and natural stimuli encountered in the real world. In one example, [symbol] ₙ can have a number of attractive properties: it is a finite-dimensional space, it allows one to work with signals of finite duration and it is particularly amenable to Fourier methods, making it well-suited for computationally-intensive applications.

Example 1: In one example, a temporal stimuli u₁=u₁(t) can be modeled as elements of the RKHS [symbol] ₁ over the domain [symbol] ₁=[0, T₁]. A signal u₁ can be written as u₁(t)=u₁(t)=Σₗ_{₁}^{L}=−L uₗ_{₁}eₗ_{₁}(t) where coefficients uₗ_{₁}ε [symbol] and the functions eₗ_{₁}(t)=exp(jl₁Ω₁t/L₁)/\sqrt{T₁}, l₁=−L₁, . . . , L₁ can form an orthonormal basis for the (2L₁+1)-dimensional space [symbol] ₁.

Example 2: In one example spatio-temporal (video) stimuli u₃=u₃ (x, y, t) can be modeled as elements of the RKHS [symbol] ₃ defined on [symbol] ₃=[0, T₁]×[0, T₂]×[0, T₃], where T₁=2πL₁/Ω₁, T₂=2πL₂/Ω₂, T₃=2πL₃/Ω₃, and (Ω₁, L₁), (Ω₂, L₂) and (Ω₃, L₃) denote the (bandwidth, order) pairs in spatial directions x, y and in time direction t, respectively. A video u₃ can be written as

$${u}_{3} ( x , y , t ) = {\sum }_{{l}_{1} = - {L}_{1}}^{{L}_{1}} {\sum }_{{l}_{2} = - {L}_{2}}^{{L}_{2}} {\sum }_{{l}_{3} = - {L}_{3}}^{{L}_{3}} {u}_{{l}_{1} {l}_{2} {l}_{3}} {e}_{{l}_{1} {l}_{2} {l}_{3}} ( x , y , t ) , \qquad ( Equation 4 )$$

where the functions eₗ_{₁}l₂l₃(x, y, t)=exp(jl₁Ω₁x/L₁+jl₂Ω₂y/L₂+jl₃Ω₃t/L₃+)/\sqrt{T₁T₂T₃} form an orthonormal basis for the (2L₁+1)(2L₂+1(2L₃+1)-dimensional space [symbol] ₃ and coefficients uₗ_{₁}l₂l₃ε [symbol] , l₁=−L₁, . . . , L₁, l₂=−L₂, . . . , L₂, l₃=−L₃, . . . , L₃

### Example 3

### Nonlinear Dendritic Stimulus Processing

In one embodiment, in order to accommodate the nonlinear dendritic computation, including multiplicative stimulus interactions frequently reported in the literature, and in order to make the neural circuit architecture of FIG. 7B generalizable, the truncated well-known Volterra series can be used to describe the computations performed by DSPs.

The Volterra series can be similar to the well-known Taylor series. However, in one example, the Taylor series can describe a nonlinear system output at any moment in time only as a function of the input at that time, the Volterra series can incorporate ‘memory’, or dependence of the system output on all other times. Furthermore, by extension of the Weierstrass polynomial approximation theorem for nonanalytic continuous functions, the Volterra series can be applicable to any continuous functional, including nonanalytic (nondifferentiable) functionals. In one example, this can render the Volterra series applicable to physiological systems, since such systems are not necessarily discontinuous.

In one embodiment, the Volterra formalism can be been applied to study physiological systems. However, in the case of neural circuits, the Volterra series can be used (i) either in cascade with a thresholding device which does not capture the spike generation dynamics or (ii) to model the input/output behavior of the entire neuron, thereby confounding the processing within the dendritic tree and the nonlinear contribution of the spike generator. Furthermore, the Volterra series approach can be applied, as described in the disclosed subject matter, in the system identification setting, without any connections drawn to the neural decoding problem.

In one example, the Volterra series can be used to describe the computation performed within the dendritic tree of a neuron. In another example, a separate nonlinear dynamical system such as the integrate-and-fire (IAF) neuron or the well-known Hodgkin-Huxely (HH) neuron can describe the generation of spikes.

FIG. 8A, FIG. 8B, FIG. 8C, and FIG. 8D illustrate exemplary DSP examples in accordance with the disclosed subject matter. FIG. 1A illustrates exemplary Pth-order temporal Single Input, Single Output (SISO) DSP with M=1 input. FIG. 8B illustrates 2nd order temporal Multiple Input, Multiple Output (MSO) DSP with M=2 inputs. FIG. 8C illustrates an exemplary motion energy DSP describing computation within a complex visual cell. FIG. 8D illustrates an exemplary DSP describes an exemplary gain control/adaptation model.

FIG. 8A, FIG. 8B, FIG. 8C, FIG. 8D can further illustrate examples of dendritic stimulus processors amenable to the Volterra approach. These examples can include: as illustrated in FIG. 8A, the single-input single-output (SISO) DSP receiving only one input and performing nonlinear transformations of arbitrary order P; as illustrated in FIG. 8B the multi-input single-output (MISO) DSP acting on several inputs simultaneously and modeling the interaction between them; as illustrated in FIG. 8C the motion energy DSP describing a complex cell model of phase and contrast invariance in certain visual neurons; and as illustrated in FIG. 8D the gain control DSP which is often encountered in neural circuits.

### Example 3A

### Single-Input Single-Output DSPs

As illustrated in FIG. 8A, a generic SISO DSP can process a stimulus uₙε [symbol] ₙ of arbitrary dimension n. An example case of temporal stimuli, i.e., stimuli of dimension n=1, will be addressed.

FIG. 8A illustrates an exemplary block diagram of a temporal SISO dendritic stimulus processor. As illustrated in FIG. 8A, this SISO DSP can be associated with the neuron iε [symbol] in the neural population setting of FIG. 7A and FIG. 7B and it can receive only one input u₁=u₁(t), tε [symbol] ₁. The DSP can perform stimulus transformations of orders p=1 through p=P and the aggregate dendritic current v¹(t), tε [symbol] ₁, at its output is given by the truncated Volterra series:

$${v}^{i} ( t ) - {𝒱}^{P} [ {u}_{1} ] {=}^{Δ} {\int }_{{𝔻}_{1}} {u}_{1} ( s ) {h}^{i 1} ( t - s ) d s ++ \text{?} {u}_{1} ( {s}_{1} ) {u}_{1} ( {s}_{2} ) {h}^{i 2} ( t - {s}_{1} , t - {s}_{2} ) d {s}_{1} d {s}_{2} + … ++ {\int }_{{D}_{1}^{P}} {u}_{1} ( {s}_{1} ) … {u}_{1} ( {s}_{P} ) {h}^{iP} ( t - {s}_{1} , … , t - {s}_{P} ) d {s}_{1} … d {s}_{P} , \\ \text{?} \text{indicates text missing or illegible when filed} \qquad ( Equation 5 )$$

where [symbol] ^{P}: [symbol] ₁→ [symbol] , and the kernels h^{ip}, p=1, . . . , P, can serve as weights of past and present values of the input signal uₗ and represent DSP-specific computing signatures. It can be noted that, in one example, the first-order kernel hⁱ¹ represents linear signatures of the dynamical system and corresponds to linear transformations of the input stimulus u₁. Higher-order kernels can be functions of two and more variables and describe nonlinear multiplicative interactions between the past and present values of the signal u₁. In one example, for a SISO DSP, the kernels can also be symmetric with respect to their arguments. For example, second order kernels can be symmetric about the diagonal t₂=t₁ since the contribution of the term u₁ (t−t₁)u₁(t−t₂) is the same as that of u₁(t−t₂)u₁(t−t₁). In one embodiment, a formulation of the Volterra series can include a zeroth-order kernel hⁱ⁰, which can model the system response in the absence of an input. However, in one embodiment, for shift-invariant systems hⁱ⁰=const can be taken to be zero. In one example, this term can be omitted in the discussion below.

In one example, the output vⁱ¹(t), tε [symbol] ₁, of the top block in FIG. 8A can correspond to the response of a temporal receptive field often modeling the linear component in a traditional linear-nonlinear setting. In another example, the additional outputs v^{ip}(t), p=2, . . . , P, can correspond to nonlinear transformations of the stimulus that the LN model does not necessarily capture.

In one example, Kernels h^{ip}, p=1, . . . , P, of the truncated Volterra series above can be assumed to be causal, i.e., their output can depend on the past and present values of the input, and bounded-input bounded-output (BIBO) stable. It can be assumed that a kernel h^{ip} has a finite support, or memory, for every order p=1, . . . , P. In other words, h^{ip} can belong to the filter kernel space Hₙ^{p} (with n=1) defined below.

Definition 2

The Filter Kernel Space Hₙ^{p}, nε [symbol] , pε [symbol] , is Given by Hₙ^{p}={h^{p}ε [symbol] ¹( [symbol] ₙ^{p})}.

One example of the nonlinear transformation performed by a SISO DSP is the polynomial trans-formation [symbol] ^{P̅}[u₁]=a₁u₁+a₂u₁² +̅ . . . +̅ a₁a. The corresponding (causal) Volterra kernels are given by h^{f1}=a₁δ(t), h^{f2}=a₂δ(t₁, t₂), . . . , h^{tP}=aₚδ(t₁, . . . tₚ), where δ(t₁, . . . tₚ) is the Dirac-delta function in P dimensions. However, the kernel structure need not be simple and the DSP can perform arbitrary nonlinear transformations of orders p=1, . . . , P.

### Example 3B

### Multi-Input Single-Output DSPs

As illustrated in FIG. 8B, the formalism described in the disclosed subject matter can be extended to dendritic stimulus processors with multiple inputs. Such MISO DSPs can describe multiplicative interactions between input stimuli and can be used, for example, to perform coincidence detection and to discriminate temporal sequences.

As further illustrated in FIG. 8B, for an exemplary MISO DSP with two inputs u₁ε [symbol] ₁, a₁ε [symbol] ₁ and maximal order P=2, the aggregate dendritic current vⁱ of a neuron i is given by

$${v}^{i} ( t ) = {𝒱}^{2} [ {u}_{1} \cdot {w}_{1} ] {=}^{Δ} {\int }_{{𝔻}_{1}} {h}^{i \vert 10} ( {s}_{1} ) {u}_{1} ( t - {s}_{1} ) d {s}_{1} ++ {\int }_{{𝔻}_{1}} {h}^{i \vert 01} ( {s}_{1} ) {w}_{1} ( t - {s}_{1} ) d {s}_{1} ++ {\int }_{{𝔻}_{1}^{2}} {h}^{i \vert 20} ( {s}_{1} , {s}_{2} ) {u}_{1} ( t - {s}_{1} ) {u}_{1} ( t - {s}_{2} ) d {s}_{1} d {s}_{2} + + {\int }_{{𝔻}_{1}^{2}} {h}^{i \vert 02} ( {s}_{1} , {s}_{2} ) {w}_{1} ( t - {s}_{1} ) {w}_{1} ( t - {s}_{2} ) d {s}_{1} d {s}_{2} ++ {\int }_{{𝔻}_{1}^{2}} {h}^{i \vert 11} ( {s}_{1} , {s}_{2} ) {u}_{1} ( t - {s}_{1} ) {w}_{1} ( t - {s}_{2} ) d {s}_{1} d {s}_{2} , \qquad ( Equation 6 )$$

where the kernels h^{i|p}^{₁}^{p}^{₂} convolve p₁ times with u₁ and p₂¹ times with wₜ. For p₁p₂≠0, the kernel h^{p}^{₁}^{p}^{₂} models the cross-coupling between stimuli u₁ and w₁. In contrast to other kernels, the cross-coupling kernel h^{i|11} is not symmetric, since the contribution of the term u₁(t−t₁)w₁(t−t₂) in general is not the same as that of the term u₁(t−t₂)w₁(t−t₁).

### Example 3B

### Motion Energy DSPs

As illustrated in FIG. 8C, the Volterra approach for modeling the stimulus processing is not limited to stimuli that are only functions of time. In one example, it can accommodate stimuli of any dimension, including visual stimuli that are functions of space and time. For example, complex cells of the primary visual cortex (V1) can exhibit non-trivial computational properties such as direction-selectivity and phase- and contrast-invariance. One model for describing motion perception with complex cells can be the motion energy model.

FIG. 8C illustrates an exemplary block-diagram of the model. The visual signal u₃=u₃(x, y, t), (x, y, t)ε [symbol] ₃, can appear as an input to two linear spatio-temporal receptive fields with kernels hⁱ¹(x, y, t) and gⁱ¹(x, y, t). These receptive fields can have a particular orientation in the space-time continuum and are out of phase with each other so that they form a quadrature pair. In one example, functions of the two-dimensional space and time can be used, instead of the one-dimensional space and time. The outputs of the receptive fields can then be squared and summed together to produce the phase- and contrast-invariant measure of visual motion vⁱ(t), where

vⁱ(t)=[ [symbol] _{₃}u₃(x,y,s)hⁱ¹(x,y,t−s)dxdyds]²+[∫ [symbol] _{₅}u₃(x,y,s)gⁱ¹(x,y,t−s)dxdyds]². (Equation 7)

Rewriting the above, it is noted that the stimulus processing associated with a complex cell can be equivalently described by a single second-order Volterra kernel hⁱ²(x₁, x₂)=hⁱ¹(x₁)hⁱ¹(x₂)+gⁱ¹(x₁)gⁱ¹(x₂), where x₁=(x₁, y₁, t₁) and x₂=(x₂, y₂, t₂):

$${v}^{i} ( t ) = {\int }_{{𝔻}_{3}^{2}} {u}_{3} ( {x}_{1} {y}_{1} , {s}_{1} ) {u}_{3} ( {x}_{2} , {y}_{2} , {s}_{2} ) \times {h}^{i 2} ( {x}_{1} , {y}_{1} , t - {s}_{1} , {x}_{2} , {y}_{2} , t - {s}_{2} ) d {x}_{1} d {y}_{1} d {s}_{1} d {x}_{2} d {y}_{2} d {s}_{2} . \qquad ( Equation 8 )$$

It can be noted that since the motion energy DSP is a SISO DSP, the second-order kernel hⁱ² can be invariant to permutations of its arguments: hⁱ²(x₁, x₂)=hⁱ²(x₂, x₁).

### Example 3D

### Gain Control/Adaptation DSPs

FIG. 8D illustrates an exemplary form of nonlinear stimulus processing that can be encountered in neuroscience is the gain control, or adaptation. Adaptation can be observed in virtually all early sensory systems, including vision, audition and olfaction. It can be responsible for tuning the sensitivity of the sensory system so that it can efficiently encode the stimulus. For example, photoreceptors of a fruit fly Drosophila can encode natural scenes despite the light intensity varying several orders of magnitude.

FIG. 8D further illustrates an exemplary block diagram of an exemplary gain control/adaptation DSP, where a single input stimulus a₂=₁(t), tε [symbol] , is simultaneously processed by two linear kernels h^{c1} and g¹. The first kernel can be responsible for picking out particular features of the stimulus, while the second kernel can be modeling either the gain and/or an adaptation mechanism. In another example, an entire bank of filters having completely different time scales and delays can be used to capture the response of a system to a variety of stimulus conditions and to model adaptive gain control. The outputs of the kernels can be multiplied together to produce the aggregate dendritic current vⁱ(t), where

vⁱ(t)=[∫ [symbol] _{₁}u₁(s)hⁱ¹(t−s)ds][∫ [symbol] _{₂}u₁(s)gⁱ¹(t−s)ds]. (Equation 9)

Similarly to the motion energy DSP, the nonlinear transformation performed by the gain control/adaptation DSP can be described by a single second-order Volterra kernel hⁱ²(t₁, t₂)=hⁱ¹(t₁)gⁱ¹(t₂):

vⁱ(t)=∫ [symbol] _{₁}_{²}u₁(s₁)u₁(s₂)hⁱ²(t−s₁,t−s₂)ds₁ds₂. (Equation 10)

It is noted that the particular form of the kernel hⁱ² above is not symmetric with respect to its arguments since in general hⁱ¹(t₁)gⁱ¹(t₂)≠hⁱ¹(t₂)gⁱ¹(t₁). However, such a kernel can be transformed into a symmetric kernel without affecting the input/output relationship of the system. Specifically, the symmetric kernel

$${h}_{sym}^{i 2} ( {t}_{1} , {t}_{2} ) = \frac{{h}^{i 2} ( {t}_{1} , {t}_{2} ) + {h}^{i 2} ( {t}_{2} , {t}_{1} )}{2} \qquad ( Equation 11 )$$

yields the same dendritic current vⁱ as the kernel hⁱ².

### Example 4

### Nonlinear Spike Generation

In one exemplary embodiment, when combined with an asynchronous sampler, for example, a point neuron model for spike generation, the DSPs illustrated in the disclosed subject matter can form a Volterra Time Encoding Machine (Volterra TEM). Volterra TEMs can represent a general class of time encoders with nonlinear preprocessing and subsume the traditional TEMs employing linear filters that have been previously reported in the literature.

In another embodiment, as is the case with traditional TEMs, Volterra TEMs can employ a myriad of spiking neurons as asynchronous samplers. Several examples include conductance-based models such as Hodgkin-Huxley, Morris-Lecar, Fitzhugh-Nagumo, Wang-Buzsaki, Hindmarsh-Rose as well as arbitrary oscillators with multiplicative coupling and models, for example simpler models such as the leaky and ideal integrate-and-fire (IAF) neurons, or the like. In one example, the ideal IAF neuron can be used.

FIG. 9 illustrates an exemplary neural circuit that includes 1) a SISO DSP, which performs nonlinear analog processing and 2) an ideal IAF encoder in cascade with the SISO DSP—where the exemplary neural circuit has a temporal input u₁ in accordance with the disclosed subject matter. As illustrated in FIG. 9, in this circuit, a temporal input signal u₁ε [symbol] ₁ is passed through a SISO DSP and then encoded by an ideal IAF neuron with a bias bⁱε [symbol] +, a capacitance Cⁱε [symbol] + and a threshold δⁱε [symbol] +, where iε [symbol] denotes the neuron number in the context of the neural population setting of FIG. 7A and FIG. 7B. The output of the circuit is a sequence of spike times (tₖⁱ)kε [symbol] on the time interval [0, T₁], indexed by the subscript kε [symbol] . The operation of this TEM can be described by the set of equations

$${\int }_{{t}_{k}^{i}}^{{t}_{k + 1}^{i}} {v}^{i} ( s ) d s = {q}_{k}^{i} , k ∈ ℤ , \qquad ( Equation 12 )$$

where vⁱ is the aggregate dendritic current at the output of the DSP and qₖⁱ=Cⁱδⁱ−bⁱ(tₖ₊₁ⁱ−tₖⁱ). Intuitively at every spike time tₖ₊₁the ideal IAF neuron is providing a measurement qₖ² of the current vⁱ(t) on the time interval [tₖⁱ, tₖ₊₁ⁱ).

Definition 3

The mapping of an input stimulus into an increasing sequence of spike times by a TEM (as in Equation 12) can be called the t-transform.

### Example 5

### Volterra Time Decoding Machines

In one example, the neural decoding problem for a class of circuits is illustrated. In this example, it can be assumed that parameters of both the DSP and the spike generator are known, and the following elements are to be found: (i) construct algorithms for recovering the stimuli from spikes produced by Volterra TEMs and (ii) specify conditions under which such recovery can occur.

In one example, the decoding problem can be different from the setting of traditional Time Decoding Machines (TDMs) since the input stimulus can be nonlinearly processed by the DSP before being encoded into spikes.

In this example, writing down the t-transform (Equation 12) for the dendritic current vⁱ(t)= [symbol] ^{P}[u₁] produced by the SISO DSP, the following can be obtained:

$${q}_{k}^{i} = {\int }_{{t}_{k}^{i}}^{{t}_{k + 1}^{i}} [ {\int }_{{𝔻}_{1}} {h}^{i 1} ( {s}_{1} ) {u}_{1} ( t - {s}_{1} ) d {s}_{1} ++ {\int }_{{𝔻}_{1}^{2}} {h}^{i 2} ( {s}_{1} , {s}_{2} ) {u}_{1} ( t - {s}_{1} ) {u}_{1} ( t - {s}_{2} ) d {s}_{1} d {s}_{2} + … ++ {\int }_{{𝔻}_{1}^{p}} {h}^{iP} ( {s}_{1} , … , {s}_{P} ) {u}_{1} ( t - {s}_{1} ) … {u}_{1} ( t - {s}_{P} ) d {s}_{1} … d {s}_{P} ] d t . \qquad ( Equation 13 )$$

In one example, it can be apparent that in contrast to current TDMs, the t-transform above cannot be written down as a linear functional acting on the stimulus u₁ due to the nonlinear multiplicative interactions introduced by the truncated Volterra series.

However, in one example, the problem can become tractable if it is considered in higher dimensions. Specifically, defining

u₁^{p}(t₁,t₂, . . . ,tₚ) [symbol] u₁(t₁)u₁(t₂) . . . u₁(tₚ), (Equation 14)

p=1, . . . , P, a p-dimensional stimulus is obtained. It can be verified that u₁^{P} belongs to the p-fold tensor product space [symbol] ₙ^{p} (with n=1) defined below.

Definition 4:

The p-fold tensor product space [symbol] ₙ^{p} [symbol] [symbol] ^{p} [symbol] ₙ. The space [symbol] ₙ^{p} over the domain [symbol] ₙ^{p} is also an RKHS with a reproducing kernel Kₙ^{p}(x₁, . . . , xₚ; y₁, . . . , yₚ)=Πⱼ₌₁^{p}Kₙ(xⱼ; yⱼ)

Treating the contribution of the p^{th}-order term of the Volterra series as if it were produced by the p-dimensional signal u₁^{p}ε [symbol] ₁^{p}, the t-transform of an exemplary neural circuit that includes 1) a SISO DSP, which performs nonlinear analog processing and 2) an ideal IAF encoder in cascade with the SISO DSP in (Equation 13) can be written as

$${q}_{k}^{i} = {\sum }_{p = 1}^{P} {𝒯}_{k}^{ip} [ {u}_{1}^{p} ] \qquad ( Equation 15 )$$

where the transformations [symbol] ₖ^{ip}: [symbol] ₁^{p}→ [symbol] , p=1, . . . , P, k¹, are linear functionals given by

$${𝒯}_{k}^{ip} [ {u}_{1}^{p} ] = {\int }_{{t}_{k}^{i}}^{{t}_{k + 1}^{i}} [ \begin{matrix}{\int }_{{𝔻}_{1}^{p}} {h}^{ ip} ( {s}_{1} , … , {s}_{p} ) \\ {u}_{1}^{p} ( t - {s}_{1} , … , t - {s}_{p} ) d {s}_{1 } … d {s}_{p}\end{matrix} ] d t , \qquad ( Equation 16 )$$

for all i=1, . . . , N and kεZ.

In other words, the spike times (tₖ)kε [symbol] generated by a Volterra TEM of order P in response to a stimulus u₁ can be interpreted as linear measurements of the sum of higher-dimensional signals, namely the tensor stimulus products u₁^{p}, p=1, . . . , P.

Given the re-interpreted t-transform (Equation 15), in one example all tensor products u₁^{p}, p=1, . . . , P, provided that each kernel h^{ip} has a spectral support that is larger than that of u₁^{p}. For a stimulus u₁ε [symbol] ₁, it is clear that the decoding problem requires Σₚ₌₁^{P}(2L₁+1)^{p} measurements to specify the coordinates for all signals u₁^{p}, p=1, . . . , P. Since a single neuron can provide 1 only a limited number of measurements in an interval of length T₁, it follows that in general the decoding problem is tractable only in the context of a multiple number of neurons N encoding a single input n₁.

Theorem 1 (Temporal SIMO Volterra TDM)

Let the signal n₁ε [symbol] ₁ be encoded by a P^{th}-order system that includes an exemplary neural circuit that includes 1) a SISO DSP, which performs nonlinear analog processing and 2) an ideal IAF encoder in cascade with the SISO DSP—where the exemplary neural circuit has a Volterra TEM with a total of N neurons, all having distinct DSPs with linearly independent kernels. Given the coefficients hₗ_{₁}ⁱ, . . . , lₚ of kernels h^{ip}, i=1, . . . , N, p=1, . . . , P, the tensor stimulus products u₁^{p}ε [symbol] ₁^{p}, can be perfectly recovered from the N-dimensional spike train (tₖⁱ)ᵢ₌₁^{N}, kε [symbol] , as

$${u}_{1}^{p} ( {t}_{1} , … , {t}_{p} ) = {\sum }_{{l}_{1} = - L}^{L} … {\sum }_{{l}_{p} = - L}^{L} {u}_{{l}_{1} … {l}_{p}} {e}_{{l}_{1} … {l}_{p}} ( {t}_{1} , … , {t}_{p} ) , \qquad ( Equation 17 )$$

p=1, . . . , P, where μi_{1 . . .} iₚ, are elements of the vector u=Φ⁺q, and Φ⁺ denotes the pseudoinverse of Φ. Furthermore, Φ=[Φ¹; Φ²; . . . ; Φ^{N}], q=[q¹; q²; . . . ; q^{N}] and [qⁱ]ₖ=qₖⁱ. Each matrix Φⁱ=[Φ₁ⁱ, Φ₂ⁱ, . . . , Φₚⁱ], with elements

$${\{ {Φ}_{p}^{i} ]}_{kl} = \{ \begin{matrix}\text{?} ( {t}_{k + 1}^{i} - {t}_{k}^{i} ) , & {\sum }_{p}^{ } {l}_{p} = 0 \\ \frac{\text{?} \text{?} \sqrt{T} [ \text{?} ( {t}_{k + 1}^{i} ) - \text{?} ( {t}_{k}^{i} ) ]}{j ( {l}_{1} + … + {l}_{p} ) {Ω}_{1}} , & {\sum }_{p}^{ } {l}_{p} \neq 0\end{matrix} , \\ \text{?} \text{indicates text missing or illegible when filed} \qquad ( Equation 18 )$$

where the column index l traverses all subscript combinations of l₁, l₂, . . . , lₚ. A necessary condition for recovery is that the total number of spikes generated by all neurons is larger than Σₙ₌₁^{P}(2L₁+1)^{p}+N. If each neuron produces [symbol] spikes in an interval of length T₁, a sufficient condition is

$$N \geq \{ \begin{matrix}⌈ \frac{{\sum }_{p = 1}^{P} {( 2 {L}_{1} + 1 )}^{p}}{v - 1} ⌉ , & v < 2 {PL}_{1} + 2 \\ ⌈ \frac{{\sum }_{p = 1}^{P} {( 2 {L}_{1} + 1 )}^{p}}{2 {PL}_{1} + 1} ⌉ , & v \geq 2 {PL}_{1} + 2 ,\end{matrix} \qquad ( Equation 19 )$$

Where ┌x┐ denotes the smallest integer greater than x.

Proof:

Writing (Equation 15) for stimuli u₁^{p}, p=1, . . . , P:

$$\begin{matrix}{q}_{k}^{i} = {\sum }_{p = 1}^{P} {𝒯}_{k}^{ip} [ {u}_{1}^{p} ] \\ = {\sum }_{p = 1}^{P} 〈 {u}_{1}^{p} , {φ}_{k}^{ip} 〉 = \\ = {\sum }_{p = 1}^{P} [ {\sum }_{{l}_{1} = - {L}_{1}}^{{L}_{1}} … {\sum }_{{l}_{p} = - {L}_{1}}^{{L}_{1}} {u}_{{l}_{1} … {l}_{p}} \overline{{φ}_{{l}_{1} … {l}_{p} , k}^{i}} ] ,\end{matrix} \qquad ( Equation 20 )$$

where the second equality follows from the well-known Riesz representation theorem with φₖ^{ip}ε [symbol] ₁^{p}. In matrix form, qⁱ=Φⁱu, with [qⁱ]ₖ=qₖⁱ, Φⁱ=[Φ₁ⁱ, Φ₂ⁱ, . . . , Φ_{P}ⁱ], where elements [Φₚⁱ]kl are given by [Φₚⁱ]kl= φ̅ₗ̅_̅{̅₁̅}̅_̅{̅.̅ .̅ .̅ l̅}̅_̅{̅ₚ̅}̅ₖ̅ⁱ̅≡ [symbol] ₖ^{ip}(eₗ_{₁}_{. . . l}_{ₚ}) with the column index l traversing all subscript combinations of l₁, l₂, . . . , lₚ and [u]ₗ=uₗ. Repeating for all neurons i=1, . . . , N, leads to q=Φu with Φ=[Φ¹; Φ²; . . . ; Φ^{N}] and q=[q¹; q²; . . . ; q^{N}]. This system of linear equations can be solved for u, provided that the rank r(Φ) of matrix Φ satisfies r(Φ)=Σₚ₌₁^{P}(2L₁+1)^{p}. A necessary condition for the latter is that the total number of spikes generated by all N neurons is greater or equal to Σₚ₌₁^{P}^{^{−}}(2L₁+1) ^{p̅}+N. Then the solution can be computed as u=Φ+q. To find the sufficient condition, for a P-t5 order system, the dendritic current v has a maximal bandwidth of PΩ₁ and 2PL₃+ measurements are needed to specify it. Thus each neuron can produce a maximum of only 2PL₁+1 informative measurements, or equivalently, 2PL₁+2 informative spikes on an interval |0,T₁|. It follows that if each neuron generates v≧2PL₁+2 spikes, the minimum number of neurons N=┌Σₚ₌₁^{P}(2L₁+1)^{p}/(2PL₁+1)┐. Similarly, if each neuron generates v<2PL₁+2 spikes, the sufficient condition is that the minimum number of neurons

N=┌Σₚ₌₁^{P}(2L₁+1)^{p}/(v−1)┐. (Equation 21).

Remark 3: In the best-case scenario that each neuron produces v>2PL₁+2 spikes, the neural population size N(P)= [symbol] (L₁^{P-1}) for fixed L₁, where [symbol] denotes Landau's big-O notation. In other words, in general multiple neurons N are required to faithfully encode a non-linearly processed temporal stimulus u₁ε [symbol] ₁, and the neural population size grows exponentially with the order P. For linearly-processed one-dimensional stimuli, i.e., P=1 and n=1, N≧1 can be obtained.

FIG. 10A and FIG. 10B illustrate an exemplary SIMO Volterra TDM algorithm. FIG. 10A illustrates an exemplary Tensor product interpretation of stimulus encoding with the temporal SIMO Volterra TEM. FIG. 10B illustrates an exemplary block diagram of SIMO Volterra TDM.

FIG. 10A illustrates an exemplary block diagram of the tensor product interpretation of temporal stimulus encoding with a Volterra TEM. FIG. 10B illustrates an exemplary stimulus reconstruction from spikes, as provided by a Volterra TDM. It can be noted that multiple stimuli up of different dimensionality appear at the input to the neural circuit. As a result, the overall architecture of the Volterra TEM is similar to a multisensory TEM in which contributions of stimuli from different modalities are multiplexed on the level of individual neurons. In one example, specifically, a common unlabeled pool of spikes is used to simultaneously represent information about all stimuli, with each spike train carrying information about all signals u₁^{p}, p=1, . . . , P.

In one example, Volterra TDM algorithms for recovering stimuli encoded with the other Volterra TEMs can similarly be derived. In this example, they are omitted, but for multidimensional stimuli, the necessary condition for recovery can be that the total number of spikes is larger than Σₚ₌₁^{P}^{^{−}}Π=α=1ⁿ(2L_{α}+1)^{p}+N, where L_{α} is the order of the stimulus space in dimension x_{α} (see also Definition 1). If each neuron produces v spikes in an interval of length T, the sufficient condition is

$$N \geq \{ \begin{matrix}⌈ \frac{{\sum }_{p = 1}^{P} {\prod }_{α = 1}^{n} {( 2 {L}_{α} + 1 )}^{p}}{v - 1} ⌉ , & v < 2 {PL}_{n} + 2 \\ ⌈ \frac{{\sum }_{p = 1}^{P} {\prod }_{α = 1}^{n} {( 2 {L}_{α} + 1 )}^{p}}{2 {PL}_{n} + 1} ⌉ , & v \geq 2 {PL}_{n} + 2 ,\end{matrix} \qquad ( Equation 22 )$$

where Lₙ denotes the order of the space in the temporal dimension xₙ=t (see also Remark 2). If each neuron produces more than 2Lₙ+2 spikes, then for P=1 the following can be obtained:

N≧┌Π_{α=1}ⁿ⁻¹(2L_{α}+1)┐.

Remark 4: In the limiting case of an infinite order L₁ and fixed bandwidth Ω₁, the period T₁=2πL₁/Ω₁ also becomes infinite. For linearly processed temporal stimuli, i.e., for P=1 and n=1, the necessary condition is:

$$\begin{matrix}{𝒟}_{pop} \geq {lim}_{{T}_{1} \to ∞} \frac{2 {L}_{1} + 1 + N}{{T}_{1}} \\ = {lim}_{{T}_{1} \to ∞} \frac{{Ω}_{1} {T}_{1} / π}{{T}_{1}} \\ = \frac{{Ω}_{1}}{π} ,\end{matrix} \qquad ( Equation 23 )$$

where Dₚₒₚ is the density of spikes of the entire population of neurons. This is exactly the necessary condition Dₚₒₚ≧N, where N=Ω₁/π it is the Nyquist rate, when input stimuli are elements of the well-known Paley-Wiener space of bandlimited functions. For n≧1 and P≧1, it can be checked that the corresponding necessary population density condition is

$${𝒟}_{pop} \geq {\sum }_{p = 1}^{P} {\prod }_{α = 1}^{n} {( \frac{{Ω}_{a}}{π} )}^{p} = {\sum }_{p = 1}^{P} {\prod }_{α = 1}^{n} {𝒩}_{α}^{P} . \qquad ( Equation 23.1 )$$

where N_{α}=Ω_{α}/π is the Nyquist rate corresponding to each stimulus dimension x_{α}, α=1, . . . , n. Similarly, since the maximal informative spike density of a single neuron is [symbol] =P [symbol] ₙ, the sufficient condition is given by

$$N \geq \{ \begin{matrix}⌈ \frac{1}{𝒟} {\sum }_{p = 1}^{P} {\prod }_{α = 1}^{n} {𝒩}_{α}^{p} ⌉ , & 𝒟 < P {𝒩}_{n} \\ ⌈ \frac{1}{P {𝒩}_{n}} {\sum }_{p = 1}^{P} {\prod }_{α = 1}^{n} {𝒩}_{α}^{p} ⌉ , & 𝒟 \geq P {𝒩}_{n} .\end{matrix} \qquad ( Equation 24 )$$

For temporal stimuli, i.e, n=1, this simplifies to

$$N \geq \{ \begin{matrix}⌈ \frac{1}{𝒟} {\sum }_{p = 1}^{P} {𝒩}^{P} ⌉ , & 𝒟 < P 𝒩 \\ ⌈ \frac{1}{P} {\sum }_{p = 0}^{P - 1} {𝒩}^{P} ⌉ , & 𝒟 \geq P 𝒩 .\end{matrix} \qquad ( Equation 25 )$$

Thus, as in Remark 3, the neural population size that is required to faithfully represent a nonlinearly-processed temporal stimulus can grow exponentially with the order P of the truncated Volterra series.

The results above can have important consequences for problems related to neural encoding and decoding with circuits encompassing nonlinear dendritic processing.

In one example, nonlinear interactions, such as those introduced by the Volterra series, can increase the resultant signal bandwidth by inducing higher frequency components into the aggregate dendritic current. In order for a neural circuit to faithfully encode the nonlinearly processed stimulus, each neuron in the population can need to generate more spikes than in the case of a linearly processed stimulus. Furthermore, since (a) neurons are relatively slow devices and (b) each neuron in the population can generate only a small number of informative measurements, the population of neurons also needs to be larger. Thus the major implication of the above results is that the size of a population of neurons dedicated to a particular task is determined not only by the stimulus properties (e.g., bandwidth), but also by the particulars of the computation performed. As a result, nonlinear processing and any non-trivial computation can be studied, for example, not on the level of individual neurons, but the neural population as a whole.

### Example 6

### Volterra Channel Identification Machines

In one embodiment, the following nonlinear neural circuit identification problem is illustrated: given the stimulus at the input to the SISO Volterra TEM circuit and the spikes observed at its output, what is the overall non-linear transformation that maps the stimulus into the dendritic current? In other words, what are the kernels h^{ip}, p=1, . . . , P, of the i-th DSP.

In one embodiment, identification problems of this kind can be related to the decoding problem discussed in the disclosed subject matter. In one example, the two classes of problems can be mathematical duals and can provide substantial insight into each other, suggesting the overall structure of the algorithms as well as the feasibility conditions for identification and decoding. In one example, specifically, it can be shown that the identification problem can be converted into a neural encoding problem, with each spike train (tₖⁱ)kε [symbol] produced during an experimental trial i, i=1, . . . , N, being interpreted as the spike train produced by the i-th neuron in a population of N neurons.

In one example, for presentation purposes, the identification of a single DSP associated with only one neuron can be considered, since identification of DSPs for a population of neurons can be performed in a serial fashion. The superscript i in h^{ip} is thus dropped herein and the p-th kernel denoted by h^{p}. Moreover, the natural notion of performing multiple experimental trials can be introduced and the same superscript i can be used to index stimuli uₙⁱ and their tensor products uₙ^{ip}, p=1, . . . , P, (see also (Equation 14)) on different trials i=1, . . . , N.

Definition 5

A signal uₙⁱ=uₙⁱ(x), xε [symbol] ₙ, at the input to a Volterra TEM circuit together with the resulting output [symbol] ⁱ−(tₖⁱ)kε [symbol] of that circuit is called an input/output (I/O) pair and is denoted by (uₙⁱ, [symbol] ⁱ).

Definition 6

The operator [symbol] :Hₙ^{p}→ [symbol] ₙ^{p} given by

$$( 𝒫 {h}^{p} ) ( x ) = {\int }_{{𝔻}_{n}^{p}} {h}^{p} ( y ) {K}_{n}^{p} ( y , x ) d y ,$$

with xε [symbol] ₙ^{p} is called the projection operator. In one example, the Volterra TEM can be again considered with a temporal input u₁ε [symbol] ₁ as illustrated in FIG. 9. Using the already familiar tensor product representation introduced in (Equation 14), the aggregate dendritic current vⁱ=vⁱ(t) tε [symbol] ₁, produced in response to the stimulus u₁ⁱ during the trial i is given by

$${υ}^{i} ( t ) = {𝒱}^{P} [ {u}_{1}^{i} ] {=}^{Δ} {\int }_{{D}_{1}} {u}_{1}^{i 1} ( s ) {h}^{1} ( t - s ) d s ++ {\int }_{{D}_{1}^{2}} {u}_{1}^{i 2} ( {s}_{1} , {s}_{2} ) {h}^{2} ( t - {s}_{1} , t - {s}_{2} ) d {s}_{1} d {s}_{2} + … ++ {\int }_{{D}_{1}^{P}} {u}_{1}^{iP} ( {s}_{1} , … , {s}_{P} ) {h}^{P} ( t - {s}_{1} , … , t - {s}_{P} ) d {s}_{1} … d {s}_{P} , \qquad ( Equation 26 )$$

where each signal u₁^{ip} is an element of the space [symbol] ₁^{p} p=1, . . . , P. Since [symbol] ₁^{p} is an RKHS, by the reproducing property, u₁^{ip}(t)= [symbol] u₁^{ip}(), K₁^{p}(, t) [symbol] can be obtained where t=(t₁, . . . , tₚ). It follows that the pth-order term of the Volterra series above can be written as

$${\int }_{{D}_{1}^{P}} {h}^{p} ( s ) {u}_{1}^{ip} ( t - {s}_{1} , … , t - {s}_{p} ) d s = {=}^{( a )} {\int }_{{D}_{1}^{P}} {h}^{p} ( s ) {\int }_{{D}_{1}^{p}} {u}_{1}^{ip} ( z ) \overline{{K}_{1}^{P} ( z , t - {s}_{1} , … , t - {s}_{p} )} d z d s {=}^{( b )} {\int }_{{D}_{1}^{P}} {u}_{1}^{ip} ( z ) {\int }_{{D}_{1}^{p}} {h}^{P} ( s ) \overline{{K}_{1}^{p} ( s , t - {z}_{1} , … , t - {z}_{p} )} d s d z {=}^{( c )} {\int }_{{D}_{1}^{p}} {u}_{1}^{ip} ( z ) ( 𝒫 {h}^{p} ) ( t - {z}_{1} , … , t - {z}_{p} ) d z , \qquad ( Equation 27 )$$

where s=(s₁, . . . , sₚ), z=(z₁, . . . , zₚ); (a) follows from the reproducing property of the kernel K₁^{p} and Definition 2, (b) from the symmetry of K₁^{p}, and (c) from Definition 6.

Thus, the t-transform (Equation 15) can be alternatively written as

$${q}_{k}^{i} = {\sum }_{p = 1}^{P} {ℒ}_{k}^{ip} [ 𝒫 {h}^{P} ] . \qquad ( Equation 28 )$$

where the transformations [symbol] ₖ^{ip}: [symbol] ᵢ^{p}→ [symbol] , p=1, . . . , P, are linear functionals given by

$${ℒ}_{k}^{ip} [ 𝒫 {h}^{p} ] = {\int }_{{t}_{k}^{i}}^{{t}_{k + 1}^{i}} [ {\int }_{{𝔻}_{1}^{p}} ( 𝒫 {h}^{p} ) ( s ) {u}_{1}^{ip} ( t - {s}_{1} , … , t - {s}_{p} ) d s ] d t . \qquad ( Equation 29 )$$

for all i=1, . . . , N, and kε [symbol] .

In one example, the problem has been turned around so that each inter-spike interval [tₖⁱ, tₖ₊₁ⁱ) produced by the IAF neuron on experimental trial i is treated as a quantal measurement qₖⁱ of the sum of Volterra kernel projections, and not the stimulus tensor products. When considered together, (Equation 28) and (Equation 15) can provide substantial insight since they demonstrate that the non-linear identification problem can be converted into a nonlinear neural encoding problem.

In one example, a difference is that the spike trains produced by a Volterra TEM in response to test stimuli u₁ⁱ, i=1, . . . , N, carry only partial information about the underlying kernels h^{p}, p=1, . . . , P. Intuitively, the information content is determined by how well the test stimuli explore the system. More formally, given test stimuli u₁ⁱε [symbol] ₁, i=1, . . . , N, the original Volterra kernels h^{p}, are projected onto P different spaces [symbol] ₁^{p} p=1, . . . , P; and only these projections [symbol] h^{p}, p=1, . . . , P, from measurements qₖⁱ, i=1, . . . , N, kε [symbol] .

Theorem 2 (Temporal SISO Volterra CIM)

Let {u₁ⁱ|u₁ⁱε [symbol] ₁}ᵢ₌₁ [symbol] be a collection of N linearly independent stimuli at the input to a P-th order an exemplary neural circuit that includes 1) a SISO DSP, which performs a nonlinear analog processing and 2) an ideal IAF encoder in cascade with the SISO DSP—where the exemplary neural circuit has Volterra kernels h^{p}εH₁^{p} p=1, . . . , P. Given the coefficients uₗ_{₁}ⁱ, . . . , l [symbol] of tensor signals u^{ip}, i=1, . . . , N, p=1, . . . , P, the kernel projections [symbol] h^{p}, p=1, . . . , P, can be perfectly identified from a collection of I/O pairs {(u₁ⁱ, [symbol] ⁱ)}ᵢ₌₁^{N} as

$$( 𝒫 {h}^{p} ) ( {t}_{1} , … , {t}_{p} ) = {\sum }_{{l}_{i} = - L}^{L} … {\sum }_{{l}_{p} = - L}^{L} {h}_{{l}_{1} … {l}_{p}} {c}_{{l}_{1 … {l}_{p}}} ( {t}_{1} , … , {t}_{p} ) , \qquad ( Equation ( 30 )$$

where p=1, . . . , P and hₗ_{₁} . . . lₚ are elements of the vector h=Φ+q. Furthermore, Φ=[Φ¹; Φ²; . . . ; Φ^{N}], q=[q¹; q²; . . . ; q^{N}] and [qⁱ]ₖ=qₖⁱ. Each matrix Φ=[Φ₁ⁱ; Φ₂ⁱ; . . . ; Φ_{P}ⁱ], with elements

$${[ {Φ}_{p}^{i} ]}_{kl} = \{ \begin{matrix}{u}_{{l}_{1} … {l}_{p}}^{i} ( {t}_{k + 1}^{i} - {t}_{k}^{i} ) , & {\sum }_{p} {l}_{p} = 0 \\ \frac{\begin{matrix}{u}_{{l}_{1} … {l}_{p}}^{i} {L}_{1} \sqrt{{T}_{i}} \\ [ {e}_{{l}_{1} + … + {l}_{p}} ( {t}_{k + 1}^{i} ) - {e}_{{l}_{i} + … + {l}_{p}} ( {t}_{k}^{i} ) ]\end{matrix}}{j ( {l}_{1} + … + {l}_{p} ) {Ω}_{1}} , & {\sum }_{p} {l}_{p} \neq 0\end{matrix} , \qquad ( Equation 31 )$$

where the column index l traverses all subscript combinations of l₁, l₂, . . . , lₚ. The necessary condition for identification is that the total number of spikes generated in response to all N trials is larger than

Σₚ₌₁^{P}(2L₁+1)^{p}+N. (Equation 32)

If the neuron produces [symbol] spikes on each trial i=1, . . . , N, of duration T₁, then a sufficient condition is that the number of trials

$$N \geq \{ \begin{matrix}⌈ \frac{{\sum }_{p = 1}^{P} {( 2 {L}_{1} + 1 )}^{p}}{v - 1} ⌉ , & v < 2 {PL}_{1} + 2 \\ ⌈ \frac{{\sum }_{p = 1}^{P} {( 2 {L}_{1} + 1 )}^{p}}{2 {PL}_{1} + 1} ⌉ & v \geq 2 {PL}_{1} + 2\end{matrix} , \qquad ( Equation 33 )$$

Proof:

Essentially similar to the proof of Theorem 1.

Remark 5 Since the tensor product spaces [symbol] ₁^{p}, p=1, . . . , P, are completely determined by the test stimulus space [symbol] ₁, and any space [symbol] ₁ can be selected, and an arbitrarily-close identification of the original kernels made. Specifically, by an extension of convergence results, it can be shown that if each kernel has a finite energy, then each projection [symbol] h^{p} converges to the underlying Volterra kernel h^{p} in the L² norm and almost everywhere with increasing bandwidth and fixed period T.

Remark 6 The sufficient conditions for identifying projections of the Volterra kernels in spiking neural circuits are very similar to those presented in the disclosed subject matter, with N now denoting the number of trials instead of neurons.

FIG. 11A and FIG. 11B illustrates an exemplary block diagram of the identification procedure and algorithm in accordance with the disclosed subject matter. FIG. 11A illustrates an exemplary time encoding interpretation of the identification problem. FIG. 11B illustrates an exemplary block diagram of the temporal SISO Comparing this diagram to the one presented in FIG. 10A and FIG. 10B, it can be noted that neuron blocks have been replaced by trial blocks. Furthermore, the tensor products of the input stimulus u₁^{p} now appear as kernels describing the filters and the inputs to the circuit are the kernel projections [symbol] h^{p}, p=1, . . . , P.

In other words, identification of a single nonlinear SISO DSP in cascade with a single point neuron (see also FIG. 9) has been converted into a nonlinear population en-coding problem, where the artificially constructed population of N neurons is associated with the N spike trains generated in response to N experimental trials.

The following examples illustrate the performance of the decoding and identification algorithms presented in Theorems 1 and 2. The disclosed subject matter can be applied to four different DNN circuits realized using ideal IAF neurons and the four types of dendritic stimulus processors presented. In one example, first decoding a temporal stimulus is considered that is nonlinearly processed by a bank of SISO DSPs (FIG. 8A) and subsequently encoded by a population of IAF neurons. Then multiple temporal stimuli can be simultaneously processed by MISO DSPs of FIG. 8A and subsequently encoded by a population of IAF neurons. Then multiple temporal stimuli can be simultaneously processed by MISO DSPs of FIG. 8B can also be recovered from a common pool of spikes. Finally, DSPs in DNN circuits can be identified. Both the complex cell DSP acting on a spatio-temporal stimulus (FIG. 8C) and the gain control/adaptation DSP modeling the processing of a temporal signal (FIG. 8D) can be identified.

### Decoding Example 1

### Temporal SISO DSP

According to Theorem 1, the problem of decoding non-linearly-processed stimuli is in general tractable only in the setting of a population of neurons. The size of the population N is determined both by the stimulus properties (e.g., its dimensionality, bandwidth) and by the type of the computation performed.

In one example, a temporal Volterra TEM in which the dendritic stimulus processor is modeled as a truncated Volterra series with a maximal order P=2. Then given a temporal stimulus u₁ with a temporal support [0, 0.1] s and a spectral support [−60, 60] Hz, parameters of the space [symbol] ₁ are given by the period T₁=0.1 s, band-width Ω₁=2π·60 rad/s, and order L₁=Ω₁T₁/(2π)=6. Consequently, for a second-order SISO DSP the following can be at least required:

$$N = ⌈ \frac{{\sum }_{p = 1}^{2} {( 2 {L}_{1} + 1 )}^{p}}{( 2 \times 2 {L}_{1} + 1 )} ⌉ = 8 \qquad ( Equation 34 )$$

neurons to faithfully represent a nonlinearly processed stimulus u₁.

FIG. 12A and FIG. 12B illustrate exemplary kernels of a temporal SISO DSP with a maximal order P=2 in accordance with the disclosed subject matter. FIG. 12A illustrates an exemplary first-order kernel {hⁱ¹}ᵢ₌₁^{N} for a population N=0 neurons having a bandwidth of 80 Hz and were chosen randomly. FIG. 12B illustrates an exemplary corresponding second-order kernels {hⁱ²}ᵢ₌₁^{N} that were also chosen randomly and were bandlimited to 60 Hz in each temporal direction.

In one example, a Volterra TEM can be used consisting of 9 IAF neurons, each having a separate second-order DSP. The first-order kernels hⁱ¹, i=1, . . . , 9, are shown in FIG. 12A. All kernels had a bandwidth of 80 Hz and were picked randomly. Corresponding second-order kernels hⁱ², i=1, . . . , 9, plotted in FIG. 12B were also randomly chosen and had a bandwidth of 60 Hz in each direction. As expected for SISO DSPs, all second-order kernels were symmetric about the diagonal t₂=t₁.

FIG. 13A, FIG. 13B, FIG. 13C, FIG. 13D, FIG. 13E, FIG. 13F, FIG. 13G, and FIG. 13H illustrate an exemplary input/output behavior of the temporal SISO DSP in accordance with the disclosed subject matter. FIG. 13A, FIG. 13B, FIG. 13C, FIG. 13D, FIG. 13E, FIG. 13F, FIG. 13G, and FIG. 13H further illustrate the input/output behavior of the SISO DSP for one of the neurons. The input signal u₁ε [symbol] ₁ plotted in FIG. 13A was chosen randomly and normalized to have a maximum amplitude of 1. The corresponding first- and second-order kernel out-puts V⁴¹ a V⁴² of neuron #4 are illustrated in FIG. 13B and FIG. 13C, respectively. It can be noted that the aggregate dendritic current v⁴ in FIG. 13D varies faster than the input stimulus u₁. This can be direct consequence of the multiplicative interactions introduced by the second-order kernel of the DSP. In effect, the bandwidth of the current flowing into the spike initiation zone can be larger than that of the stimulus and is determined both by the stimulus itself and by the processing performed by the DSP. This can also be illustrated in FIG. 7E, FIG. 7F, FIG. 7G, FIG. 7H, where the Fourier amplitude spectrum of all signals involved are plotted. Since the first-order kernel was bandlimited to 80 Hz, it can produce a signal v⁴¹ that can have the same bandwidth of 60 Hz as the stimulus u₁. In contrast, the second-order kernel can be bandlimited to 60 Hz in each direction and thus supports all stimulus harmonics up to 120 Hz. This is indeed the case as the bandwidth of signals v⁴² and v⁴ is roughly [−120, 120] Hz.

In one exemplary embodiment, each aggregate dendritic current ⁱ, i=1, . . . , 9, produced by the i ^{t̅h̅} DSP was encoded into a spike train by a dedicated ideal IAF neuron. The entire population of 9 neurons produced a total of 281 spikes, which is more than the necessary condition of 191 spikes.

FIG. 14A, FIG. 14B, FIG. 14C, and FIG. 14D illustrates an exemplary decoding example of a temporal SISO DSP in accordance with the disclosed subject matter. FIG. 14A illustrate an exemplary original stimulus u₁ (1401) and an exemplary decoded u₁* (1403). It should be noted that the two curves are indistinguishable. FIG. 14B illustrates an exemplary absolute error between u₁ and u₁* was well below 0.05 percent. As further illustrated in FIG. 14B, the mean squared error was on the order of −70 dB. FIG. 14C illustrates an exemplary original tensor product u²₁ that is shown in different viewer (top and bottom) as a function of t₁ and t₂. FIG. 14D illustrates an exemplary decoded tensor product u₁²* is shown in the same two views (top and bottom). The mean squared error is −61 dB.

FIG. 14A, FIG. 14B, FIG. 14C, and FIG. 14D illustrates decoding results obtained using the algorithm in Theorem 1. The decoded stimulus u₁* is indistinguishable from the original signal u₁ (solid red 1403 and blue lines 1401 in FIG. 14A). The mean squared error between the two functions, computed as

$$MSE ( {u}_{1} , {u}_{1}^{*} ) = 10 \cdot {log}_{10} ( \frac{{‖ {u}_{1}^{*} - {u}_{1} ‖}_{2}}{{‖ {u}_{1} ‖}_{2}} ) , \qquad ( Equation 35 )$$

where ∥u∥₂ denotes the L² norm of u, was −69.8 decibel (dB). Similarly, the mean squared error between the original and decoded tensor products u₁²* and u₁² (FIG. 14C, FIG. 14D) was −61.0 dB.

As expected, both signals are symmetric with respect to the diagonal t₂=t₁ as the tensor product u₁²(t₁, t₂)=u₁(t₁)u₁(t₂) is invariant to permutations of its arguments. The top view of the tensor product n₁² (bottom plot of FIG. 14C) clearly illustrates that each row (column) of n₁² represents a weighted version of the stimulus u₁(t), with the multiplicative weight given by the value of the stimulus at some specific time t₂ (or t₁ for columns). At the same time, values of u(t₁, t₂) are strictly positive along the diagonal t₂=t₂ since that diagonal contains information about the square of the signal {u₁(t))²=u₁²(t, t).

### Decoding Example II

### Temporal MISO DSP

In one example, in order to demonstrate the applicability of the disclosed subject matter's exemplary approach to neurons receiving not one, but several inputs simultaneously, a dynamic nonlinear non-linear was simulated circuit with a population of temporal multi-input single-output DSPs in cascade with IAF neurons. For simplicity, both the number of inputs and the maximal order of the DSP can be limited to two (see also FIG. 8A, FIG. 8B, FIG. 8C, FIG. 8D).

In this example, all DSP kernels were chosen randomly. The two first-order kernels h^{i|10} and h^{i|01} responsible for linear processing within each neuron i were bandlimited to 80 Hz, while the three second-order kernels h^{i|20}, h^{i|02} and h^{i|11} had a bandwidth of 60 Hz in each direction. In contrast to the kernels h^{i|20} and h^{i|02}, no symmetry was imposed on the cross-coupling kernel h^{i|11}.

In one embodiment, both stimuli u₁ and w₁ were picked from the space of input signals [symbol] ₁ with a period T₁=0.1s, bandwidth Ω₁=2π·60 rad/s, and order L₁=Ω₁T₁/(2π)=6. From an extension of Theorem 1, it follows that a sufficient condition for a faithful encoding of stimuli u₁, w₁ and their stimulus products u₁², w₁² and u₁w₁ is that the neural population size is larger than or equal to

$$N = ⌈ \frac{{\sum }_{p = 1}^{2} {( 2 {L}_{1} + 1 )}^{p} + {( 2 {L}_{1} + 1 )}^{2}}{2 \times 2 {L}_{1} + 1} ⌉ = 22. \qquad ( Equation 36 )$$

A total of 50 neurons were used that altogether produced 637 spikes in response to a concurrent presentation of stimuli u₁ and w₁. This is 54 spikes more than the necessary condition of at least

$$\# ( {t}_{k} ) = 2 [ {\sum }_{p = 1}^{2} {( 2 {L}_{1} + 1 )}^{p} ] + {( 2 {L}_{1} + 1 )}^{2} + 50 = 583 \qquad ( Equation 37 )$$

spikes.

FIG. 15A, FIG. 15B, FIG. 15C, FIG. 15D illustrate an exemplary decoding example of a temporal MISO DSP in accordance with the disclosed subject matter. (FIG. 15A) (top) Two original stimuli u₁ and w₁ at the input to the MISO DSP; (middle) decoded stimuli u₁* and w₁*; (bottom) absolute decoding error. (FIG. 15B and FIG. 15C) Tensor stimulus products u²₁ and w²₁, decoded signals u₁²* and w₁²* and absolute errors are plotted in the top, middle and bottom row, respectively. It should be noted that all signals are symmetric with respect to the diagonal. (FIG. 15D) (top) Original stimulus product u₁w₁; (middle) decoded stimulus product (u₁w₁)*; (bottom) absolute error. Unlike tensor products u²₁ and w²₁, the product u₁w₁ is not symmetric.

FIG. 15A, FIG. 15B, FIG. 15C, FIG. 15D further illustrates the decoding results. The original stimuli u₁, w₁ as well as their true products u₁², w₁², u₁w₁ are plotted in the top row of FIG. 15A, FIG. 15B, FIG. 15C, FIG. 15D, respectively. The corresponding decoded stimuli and recovery errors produced by a Volterra time decoding machine are shown in the middle and bottom row of FIG. 15A, FIG. 15B, FIG. 15C, FIG. 15D. In one embodiment, as expected, u₁², w₁² were symmetric, while u₂w₁ was not. It can be observed that there is little to no difference between the original and decoded stimuli, with the mean squared error being on the order of −70 dB for one-dimensional stimuli and −60 dB for two-dimensional stimulus products.

### Identification Example I

### Motion Energy DSP

In one example, the performance of the Volterra channel identification machine is investigated, a temporal version of which was discussed earlier in the disclosed subject matter. Here, the spatio-temporal variant of the Volterra CIM is employed to identify the motion energy DSP of FIG. 8C.

The quadrature pair (λ¹, g¹) of the motion energy model can be obtained from a spatially-oriented Gabor mother wavelet

$$γ ( x , y ) = \frac{1}{\sqrt{2 π}} \text{?} [ \text{?} - \text{?} ] , \\ \text{?} \text{indicates text missing or illegible when filed} \qquad ( Equation 38 )$$

by dilating and rotating it in space and additionally imposing a temporal orientation profile. This particular form of the spatial Gabor wavelet, with j denoting the imaginary number and κ=const. can be used as a model for receptive fields of simple cells satisfying a number of mathematical and biological constraints. In this example, the kernel h¹ can correspond to the even-symmetric cosine component of γ(x, y) multiplied by a sinusoidal function of time, and g¹ corresponded to the odd-symmetric sine component of γ(x, y) multiplied by the same sinusoidal function of time.

FIG. 16 illustrates an exemplary identification of a motion energy DSP in accordance with the disclosed subject matter. First row of FIG. 16 illustrates four frames of the original first quadrature component h¹. It can be note that h¹ is an even function of space and corresponds to the cosine component of the dilated and rotated mother wavelet γ(x, y), temporally oriented by sin(2π·25t). The second row illustrates corresponding frames of the original second quadrature component g¹, which is an odd function of space. The third row illustrates square-rooted diagonal h²_{diag} of the true second-order kernel h². The fourth row illustrates Square-rooted diagonal (Ph²*)_{diag} of the identified second-order kernel Ph²*.

The domain of the quadrature pair was given by [symbol] ₃= [symbol] _{xy} [symbol] ₜ, where [symbol] _{xy} =̅[−⅙, 1/ 6̅]×[−1/ 6̅, ⅙] aū and [symbol] ₜ[0, 0.04]s. Temporal orientation was imposed by multiplying γ(x, y) by sin(2π·25t). The resultant first-order spatiotemporal kernels h¹ and g¹ are visualized in the top two rows of FIG. 16. Four different frames at times t=8, 16, 24, 32 ms clearly illustrate that the kernel h¹ (kernel g¹) is an even (odd) function of space and corresponds to the cosine (sine) component of the dilated and rotated mother wavelet γ(x, y), temporally oriented by a sinusoid that changes its sign at time t=20 ms.

In one example, in order to identify this motion energy DSP, a randomly-generated video stimuli can be employed that is bandlimited to 50 Hz in time and 12 Hz in the spatial directions x and y. For a video stimulus u₃ with a temporal support of 40 ms and spatial support of ⅙ au, this yields a temporal order L₃=2 and spatial orders L₁=L₂=2 of the stimulus space [symbol] ₃.

Thus, according to Remark 6, since the motion energy DSP can be described by a single second-order kernel (see above), it can be required that at least

$$N = ⌈ \frac{[ ( 2 {L}_{1} + 1 ) ( 2 {L}_{2} + 1 ) ( 2 {L}_{3} + 1 ) ]}{2 \times 2 {L}_{3} + 1} ⌉ = 1737 , \qquad ( Equation 39 )$$

experimental trials involving different video stimuli to identify this DSP.

In one example 1910 video stimuli of length 40 ms was used, for a total duration of 76.4 s. In response to all of these stimuli, the IAF neuron produced 25580 spikes, which is more than the necessary condition of 15626 spikes.

The performance of the spatiotemporal Volterra CIM can be summarized in the bottom two rows of FIG. 16. Since it can be hard to visualize a 6-dimensional second-order kernel h² describing the motion-energy DSP, instead the square root of its diagonal can be plotted:

$$\begin{matrix}{h}_{diag}^{2} ( x , y , t ) = \sqrt{{h}^{2} ( x , y , t , x , y , t )} ≡ \\ ≡ \sqrt{{[ {h}^{1} ( x , y , t ) ]}^{2} + {[ {g}^{1} f ( x , y , t ) ]}^{2} ,}\end{matrix} \qquad ( Equation 40 )$$

which is a function of three variables.

In one example, four frames of the true signal h_{diag}² are plotted in the third row of FIG. 16. It can be noted that the function h_{diag}² has a non-zero spatial support corresponding to the spatial extent and orientation of the combined support of kernels h² and g². The square-rooted diagonal of the identified second-order kernel [symbol] h²* can be plotted in the fourth row of FIG. 16. Although only a projection [symbol] h² of the second-order kernel h² onto the input stimulus space can be identified, the kernel [symbol] h²* computed by the algorithm evidently can show little difference from h² since the spatio-temporal bandwidth of input stimuli is sufficiently high.

### Identification Example II

### Gain/Adaptation DSP

In one example, the identification of the gain control adaptation DSP shown in FIG. 8D is considered. This is a temporal SISO DSP, in which nonlinear interactions are introduced by multiplying together two linearly processed versions h¹*u₂ and g¹*u₁ of the temporal signal u₁, where h¹*u₁ denotes the convolution of h¹ with u₁. As noted in the disclosed subject matter, the resultant second-order kernel h²(t₁, t₂)=h¹(iₓ)g¹(₂) is not invariant with respect to permutations of its arguments. However, the kernel h_{sym}²=0.5[h²(t₁, t₂)+h²(t₂, t₁)] is symmetric and provides an equivalent input/output description of the gain control/adaptation DSP.

In simulations, the two randomly chosen first-order kernels had a temporal support [0, 0.1] s. and were bandlimited to 50 Hz. Test stimuli u¹ on trials i=1, . . . , N, had the same temporal and spectral support as the two kernels and were taken from the stimulus space [symbol] ₁ with parameters Ω₁=2π·50 rad/s, T₁=9.1 s and L₁=5.

According to Theorem 2, the neuron with at least

$$N = ⌈ \frac{{( 2 {L}_{1} + 1 )}^{2}}{2 \times 2 {L}_{1} + 1} ⌉ = 5 \qquad ( Equation 41 )$$

different signals is to probed if the DSP implements only the second-order kernel, and with

$$N = ⌈ \frac{{( 2 {L}_{1} + 1 )}^{2} + ( 2 {L}_{1} + 1 )}{2 \times 2 {L}_{1} + 1} ⌉ = 7 , \qquad ( Equation 42 )$$

to attempt to recover both the first- and second-order kernels.

In this example, it can be assumed that the structure of the underlying system was not known and 8 different signals are used to identify the DSP. The neuron produced a total of 167 spikes in response to all signals, which is 27 spikes more than the necessary condition of 140 spikes.

FIG. 17A, FIG. 17B, FIG. 17C, FIG. 17D, FIG. 17E, FIG. 17F, FIG. 17G, FIG. 17H illustrate an exemplary identification example of a gain control adaptation DSP in accordance with the disclosed subject matter. FIG. 17A illustrates The original second-order kernel h²(t₁, t₂)=h¹(t₁)g¹(t₂) is not symmetric with respect to the diagonal t₂=t₁. FIG. 17B illustrates a symmetric version h_{sym}²=0.5[h²(t₁, t₂)+h²(t₂, t₁)] of h². FIG. 17C illustrates identified kernel [symbol] h²*. FIG. 17D illustrates absolute error between Ph²* and h²_{sym}. FIG. 17E and FIG. 17F illustrates original first-order kernels h¹ and g¹. FIG. 17G illustrates the original and recovered products h¹g¹ and (h¹g¹)*, as read out along the diagonal t₂=t₁ of h²_{sym} and [symbol] h²*, are illustrated in blue 1701 and red 1703, respectively. FIG. 17H illustrates an absolute error between h¹g¹ and (h¹g¹)*.

The first-order kernel of the DSP was identified as zero (data not shown) and the projection [symbol] h²* of the second kernel identified by the Volterra CIM is shown in FIG. 17C. As expected, the kernel is symmetric. The error between the true symmetric kernel h_{sym}², (FIG. 17B) and [symbol] h²* is plotted in FIG. 17D.

In one example, although the kernels h_{sym}² and [symbol] h²* show little resemblance to the non-symmetric kernel h², all three share one important property that the diagonal of the kernel is equal to the point-wise product of the first-order kernels h¹ and g¹ describing the DSP. To demonstrate this, the original kernels h¹ and g¹ can be plotted in FIG. 17E, FIG. 17F. And in FIG. 17G, the point-wise product is graphed, as it was read out along the diagonals t₂=t₁ of h_{sym}² and [symbol] h²*. The mean squared error between the original and identified point-wise products is on the order of −70 dB.

In one example, a special case of the gain control/adaptation DSP can occur when h¹(t)=g¹(t)=δ(t), where δ(t) denotes the Dirac-delta function. By the basic reproducing property of the Dirac-delta function, the output of both kernels is just the stimulus u₁. In other words, there is no processing performed by either of the kernels and the aggregate output v(t) of the DSP is just the square of the input v(t)=[u₁(t)]².

FIG. 18A, FIG. 18B, FIG. 18C illustrate an exemplary identification example of a squaring of a signal in accordance with the disclosed subject matter. FIG. 18A illustrates an exemplary theoretical value of the projection Ph² of the Dirac-delta kernel h²(t₁, t₂)=δ(t₁, t₂) describing the squaring operation. FIG. 18B illustrates Kernel Ph²* identified by a temporal Volterra CIM. FIG. 18C illustrates an exemplary error between Ph²* and Ph².

In one example, it can be assumed that both the first-order and the second-order kernels are present in the system. 14 different signals u₁ living in the same temporal space [symbol] ₁ as above, were used to identify both of these kernels. The IAF neuron produced a total 160 spikes, i.e., 14 more spikes than the necessary condition of 146 spikes. The first order kernel was zero as expected. The identified second-order kernel [symbol] h²* is shown in FIG. 18B.

It can be noted that [symbol] h²* is quite different from the Dirac-delta function, since the underlying kernel h²(t₁, t₂)=δ(t₁, t₂) has an infinite bandwidth and can never be recovered. The projection [symbol] h² of h² onto the input stimulus space can be identified. For an RKHS, this projection is equal to the reproducing kernel K. This follows directly from Definition 6 since

$$\begin{matrix}𝒫 {h}^{2} ( {t}_{1} , {t}_{2} ) = {\int }_{{𝔻}_{1}^{2}} δ ( {s}_{1} , {s}_{2} ) \overline{{K}_{1}^{2} ( {s}_{1} , {s}_{2} ; {t}_{1} , {t}_{2} )} d {s}_{1} d {s}_{2} \\ = {K}_{1}^{2} ( 0 , 0 ; {t}_{1} , {t}_{2} )\end{matrix} \qquad ( Equation 43 )$$

This theoretical value of the projection is plotted in FIG. 18C. The absolute error between [symbol] h² and the identified kernel [symbol] h²* was less than 0.05 percent over the entire domain D₁². The mean squared error was −64.1 Db.

The disclosed subject matter presented a general model for nonlinear dendritic stimulus processing in the context of spiking neural circuits that can receive one or more input stimuli and produce one or more output spike trains. Using the rigorous setting of reproducing kernel Hilbert spaces and time encoding machines, the problems of neural identification and neural encoding can be related and insight into the nature of faithful representation of nonlinearly-processed stimuli in the spike domain can be obtained.

Although proofs for specific dendritic stimulus processors acting on temporal stimuli are disclosed herein, numerous examples can be used to demonstrate that the disclosed subject matter is applicable to many nonlinear models of dendritic processing and to stimuli of any dimension. In one example, the methods discussed span all sensory modalities, including vision, audition, olfaction, touch, etc. By an extension of the disclosed subject matter, these methods can also be applied to circuits in higher brain centers, where all communication is mediated not by continuous signals, but rather by multidimensional spike trains. Furthermore, in a manner similar to the disclosed subject matter, nonlinear models of signal processing can be considered in the context of multisensory circuits concurrently processing multiple stimuli of different dimensions, as well as in the context of mixed-signal circuits processing both continuous and spiking stimuli. Such mixed-signal models are important, for example, in studying neural circuits comprised of both spiking neurons and neurons that produce graded potentials (e.g., the retina), investigating circuits that have extensive dendro-dendritic connections (e.g., the olfactory bulb), or circuits that respond to a neuromodulator (global release of dopamine, acetylcholine, etc.). The latter circuit models are important, e.g., in studies of memory acquisition and consolidation, central pattern generation, as well as studies of attention and addiction.

FIG. 19A, FIG. 19B, FIG. 19C, FIG. 19D illustrate an exemplary necessary and sufficient conditions for decoding and identification in accordance with the disclosed subject matter. FIG. 19A illustrates the necessary condition is illustrated by plotting the average MSE of a second-order temporal SISO DSP as a function of the number of spikes #(tₖ). (FIG. 19A top) generating a lot of spikes in itself does not imply that stimuli can be decoded/identified. (FIG. 19A bottom) stimuli can be recovered if the sufficient condition on the number of trials/neurons is met. In both plots, the dotted red line 1903, 1907 denotes the necessary condition. (FIG. 19B) The sufficient condition is illustrated by plotting the average MSE as a function of the number of trials/neurons N (shown in blue 1909). The sufficient condition N=12 is indicated by a dotted red line 1911. Note that roughly for the same number of spikes produced (arrows with numbers), perfect decoding/identification can be guaranteed only if the sufficient condition is met. (FIG. 19C and FIG. 19D) Same as (FIG. 19A) and (FIG. 19D) but for different parameters of the space H₁.

The problem of identifying a single dendritic stimulus processor is mathematically dual to the neural encoding problem with a population of neurons. Thus the general structure and feasibility conditions of Volterra Time Decoding Machines (Volterra TDMs) provided an insight into the architecture of Volterra Channel Identification Machines (Volterra CIMs), and vice-versa.

For example, the dual of identifying multidimensional kernels h^{p}, p=1, . . . , P, of a temporal SISO DSP is decoding multiple stimulus tensor products u₁^{p}, p=1, . . . , P. At first, it appears unnecessary to do so, since each tensor product can be computed from u₁ in a fashion (see (Equation 14)). In the most general setting, u₁ is not necessarily decodable without decoding one or more of its tensor products. This happens for example, if kernels of the first order p=1 are not implemented by the Volterra TEM. Then the identification of the tensor product 1 u₁²(t₁, t₂)=u₁(t₂|u₁(t₂) provides only the magnitude information about the stimulus, since u₁(t)=\sqrt{u₁²(t, t)}. The additional sign information can be computed from the tensor product u₁³(t₁, t₂, t₃)=u₁(t₁)u₁(t₂)u(t₃), if the latter can be recovered. In general, in order to decode the original stimulus u₁, at least one odd-order tensor product needs to be recovered. If no odd-order nonlinearities are implemented by the system, only the magnitude of the stimulus can be computed from even-order terms.

Additional insight provided by Volterra CIMs about Volterra TEMs is as follows. It can be that for some order p, the kernels h^{ip}, i=1, . . . , N, of the entire population of neurons do not provide the necessary spectral support to faithfully encode the tensor product u₁^{p}. In that case, similar to the CIM results presented in the disclosed subject matter, only some projection [symbol] n₁^{p} of the tensor stimulus onto the kernel space can be recovered. It follows that in the most general setting of the Volterra TEM, multiple stimulus tensor products can need to be decoded and analyzed in order to recover the original stimulus.

The interplay between decoding and identification can allow to develop the feasibility conditions for both. While the necessary condition on the total number of spikes presented herein follows directly from the necessary conditions for solving a convex optimization problem, it does not guarantee that the problem can be actually solved.

Further insight can be afforded by the identification methodology involving multiple experimental trials. To wit, each trial in the identification process can produce only a limited number of informative spikes, or measurements. This is because, all the complexity of dendritic processing aside, the aggregate current flowing into the spike initiation zone is just a function of time and consequently has only a few degrees of freedom. Thus, even if the neuron generates a large number of spikes in response to a particular stimulus, very few of these spikes can provide information about the processing upstream of the spike initiation zone. By using multiple different stimuli, i.e., not repeated trials of the same stimulus, one can obtain enough informative spikes to characterize the dendritic processing. Thus in addition to the necessary condition on the total number of spikes, a sufficient condition on the number of different stimuli that need to be used is obtained. Note that this is highly counterintuitive, as a lot of identification approaches suggest using stimuli that are specifically tuned to elicit a large number of spikes. However, this does not necessarily provide significant gain.

This are further illustrated in FIG. 19A, FIG. 19B, FIG. 19C, FIG. 19D. In (FIG. 19A) the average mean squared error of identification/decoding for a temporal SISO DSP of maximal order P=2 is plotted as a function of the number of spikes produced in all N=4 trials by all N=4 neurons. Since the order of the stimulus space [symbol] ₁ is L=6, the necessary condition states that the total number of spikes should be greater than (2L+1)²+(2L+1)+N=186. It can be seen however, that the MSE stays close to zero no matter how many spikes are generated, even if the total number of spikes is well beyond the necessary condition (it is assumed that each neuron/trial produces roughly the same number of spikes, i.e., the extreme case of the majority of spikes being produced in one trial or by one neuron are excluded). In plot (FIG. 19B) on the other hand, N=8 trials/neurons and the MSE approaches −70 dB well before the necessary condition is met. This suggests at the sufficient condition having been met with reference to plot (FIG. 19C), where the average MSE is depicted as a function of the number of trials/neurons used. Arrows with numbers adjacent to them indicate the total number of spikes produced in each experiment. Note the abrupt drop in MSE when N goes from 7 to 8, even though the total number of spikes produced is roughly the same and is always bigger than the necessary condition. For N≧8, the MSE stays close to −70 dB, demonstrating that this indeed is the sufficient condition for perfect recovery/identification.

Exemplarily embodiments of the disclosed subject matter have revolved around noiseless systems and spike times (tₖⁱ), i=1 . . . . , N, kε [symbol] , were used to compute ideal quantal measurements qₖⁱ of input stimuli/dendritic processing. If there is noise present either in the stimulus or in the neuron itself, it will simply introduce noise terms Eₖⁱ into the measurements qₖⁱ. A number of techniques, most notably regularization, are available for combating noise. Such techniques can be incorporated into the optimization problems presented in this paper, without changing the overall structure of the algorithm.

In particular, the necessary and sufficient conditions discussed above can become lower bounds on the number of spikes and neurons/trials and will still provide basic guidance when approaching either the neural en-coding or the neural identification problem.

It one example, it can be assumed that parameters of the spike generator are available to the observer. In practice, parameters of the spike generator can be estimated, e.g., through additional biophysical experiments.

In one example, the disclosed subject matter can be used in the context of applications in neuroscience. In another example, encoding can be performed, using the disclosed subject matter, not only by neurons, but also by any asynchronous sampler, such as an asynchronous sigma delta modulator (ASDM), an oscillator with additive or multiplicative coupling, or an irregular sampler.

The disclosed subject matter can be implemented in hardware or software, or a combination of both. Any of the methods described herein can be performed using software including computer-executable instructions stored on one or more computer-readable media (e.g., communication media, storage media, tangible media, or the like). Furthermore, any intermediate or final results of the disclosed methods can be stored on one or more computer-readable media. Any such software can be executed on a single computer, on a networked computer (for example, via the Internet, a wide-area network, a local-area network, a client-server network, or other such network), a set of computers, a grid, or the like. It should be understood that the disclosed technology is not limited to any specific computer language, program, or computer. For instance, a wide variety of commercially available computer languages, programs, and computers can be used.

A number of embodiments of the disclosed subject matter have been described. Nevertheless, it will be understood that various modifications can be made without departing from the spirit and scope of the disclosed subject matter. Accordingly, other embodiments are within the scope of the claims.

We claim:

1. A method of encoding one or more input signals in a non-linear system, comprising:
receiving the one or more input signals;
performing non-linear dendritic processing on the one or more signals to provide a first output;
providing the first output to one or more neurons; and
encoding the first output, at the one or more neurons, to provide one or more encoded signals.

2. The method of claim 1, wherein the receiving further comprises modeling the one or more input signals.

3. The method of claim 2, wherein the modeling further comprises modeling the one or more input signals using Volterra series.

4. The method of claim 1, further comprising:
modeling the one or more input signals into one or more spaces;
performing dendritic processing on each of the one or more spaces to provide an output; and
adding the output from dendritic processing of each of the one or more orders to provide a first output.

5. A method of decoding one or more encoded signals in a non-linear system, comprising:
receiving the one or more encoded signals;
performing convex optimization on the one or more encoded signals to produce a coefficient; and
constructing one or more output signals using the coefficient.

6. The method of claim 5, wherein the performing comprises:
determining a sampling matrix using the one or more encoded signals;
determining a measurement using a time of the one or more encoded signals; and
determining a coefficient using the sample matrix and the measurement.

7. The method of claim 5, wherein the constructing the one or more output signals further comprises:
determining a bias based on the one or more encoded signals; and
determining the one or more output signals based on the bias and the coefficient.

8. The method of claim 5, wherein the receiving further comprises modeling the one or more encoded signals.

9. The method of claim 8, wherein the modeling further comprises modeling using Volterra series.

10. The method of claim 5, further comprising:
modeling the one or more encoded signals into one or more orders; and
performing convex optimization on each of the one or more orders to provide the coefficient for each of the one or orders.

11. A method of identifying a projection of an unknown dendritic processor in a non-linear system, comprising:
receiving a known input signal;
processing the known input signal using a projection of the unknown dendritic processor to produce a first output;
encoding the first output, using a neuron, to produce an output signal; and
comparing the known input signal and the output signal to identify the projection of the unknown dendritic processor.

12. The method of claim 11, wherein the receiving further comprises modeling the known input signal.

13. The method of claim 12, wherein the modeling further comprises modeling the known input signal using Volterra series.

14. The method of claim 11, further comprising:
modeling the known input signal into first one or more orders; and
modeling the projection of the dendritic processor of the channel into second one or more orders.

15. The method of claim 14, for each of the first one or more orders:
processing the projection of each of the second one or more orders using the known input signal to produce a first output; and
adding the output from dendritic processing of each of the one or more orders to provide a first output.

16. A system for encoding one or more input signals, comprising:
a first computing device having a processor and a memory thereon for the storage of executable instructions and data, wherein the instructions are executed to:
receiving the one or more input signals;
performing dendritic processing on the one or more signals to provide a first output;
providing the first output to one or more neurons; and
encoding the first output, at the one or more neurons, to provide one or more encoded signals.

17. The system of claim 16, wherein the receiving further comprises modeling the one or more input signals.

18. The system of claim 17, wherein the modeling further comprises modeling the one or more input signals using Volterra series.

19. The system of claim 16, further comprising:
modeling the one or more input signals into one or more orders;
performing dendritic processing on each of the one or more orders to provide an output; and
adding the output from dendritic processing of each of the one or more orders to provide a first output.

20. The system of claim 16, further comprising:
providing the one or more encoded signals to a decoder for decoding the one or more output signals.
